(19) United States
(12) Patent Application Publication
(10) Pub. No.: US 2012/0077725 A1
(43) Pub. Date: Mar. 29, 2012

(54) FABRIC CARE FORMULATIONS AND METHODS

(76) Inventors: Xiaoru Jenny Wang, Mason, OH (US); James Lee Danziger, Mason, OH (US); David S. Salloum, West Chester, OH (US); Sohan Rajpanth Murthy, San Francisco, CA (US); Giulia Ottavia Bianchetti, Rome (IT); Yonas Gizaw, West Chester, OH (US); Edgar Manuel Marin-Carrillo, Cincinnati, OH (US); Jeffrey Scott Weaver, Cincinnati, OH (US); Mario Elmen Tremblay, West Chester, OH (US)

(21) Appl. No.: 13/237,336

(22) Filed: Sep. 20, 2011

Related U.S. Application Data
(60) Provisional application No. 61/384,449, filed on Sep. 20, 2010.

(51) Int. Cl. C11D 17/00; C11D 3/60

(52) U.S. Cl. 510/285; 510/299; 510/528

(57) ABSTRACT

Fabric care compositions for providing improved stain repellency are described. The fabric care composition includes a mixture including a hydrophobic fluid, a particulate material and an amphoteric or cationic oligomeric/polymeric deposition aid. Methods for providing improved stain repellency for a textile by treating the textile with the fabric care composition are also described.

### CROSS REFERENCE TO RELATED APPLICATION

This application claims the benefit of priority to U.S. Provisional Application Ser. No. 61/384,449, filed Sep. 20, 2010, which is herein incorporated by reference.

### FIELD OF INVENTION

The present invention is related to fabric care compositions that result in improved stain repellency for fabrics treated with the fabric care compositions. The fabric care compositions includes a stain repellency composition comprising a hydrophobic fluid and a particulate material and also containing a deposition aid which provides for uniform and higher efficiency deposition of the stain repellency composition on the surface of a textile material.

### BACKGROUND OF INVENTION

Improved removal of soils and stains is a constant aim for laundry detergent manufacturers. In spite of the use of many effective surfactants and polymers, and combinations thereof, many products still do not achieve complete removal of greasy/oily stains, colored stains and particulate soils.

An additional demand from consumers is instant or rapid stain removal at the time that the staining event occurs, so that there is no residual staining of clothes or fabrics due to accidental staining.

Fabric, especially clothing, can become soiled with a variety of foreign substances ranging from hydrophobic stains (grease, oil) to hydrophilic stains (clay). The level of cleaning which is necessary to remove these foreign substances depends to a large degree upon the amount of stain present and the degree to which the foreign substance has contacted the fabric fibers. An effective cleaning formulation is typically comprised of many technologies that aid in removal of a variety of soils. Unfortunately, due to cost and formulation constraints, it is rare to find a cleaning formulation that effectively incorporates each of the above cleaning technologies to completely remove all of the target soils and stains on fabrics or textiles. Further, the stain removal process can be tough and time consuming, while incomplete or unsatisfactory stain removal can be frustrating and result in a ruined garment.

One approach includes soil release polymers which operate by mechanisms such as providing a “strippable film” of hydrophilic polymer or other composition that can coat the fabric surface and, at least to some extent, prevent attachment of oily soils to fabric surfaces. The polymer may then be removed during the laundering or other fabric treatment process, removing the oily soil at the same time.

Alternatively, treating the fabric so that stains and soils do not effectively bind to the fabric or fiber surface may provide improved cleaning of fabrics. In this approach, the stain or soil do not bind or form strong attractive interactions with the fabric surface and can be readily removed from the fabric surface upon laundering or other treatment process. One approach may be to treat the fabric or fiber surface during the manufacturing process to form the desired fabric or fiber surface that exhibits the desired stain repellency. With this approach, one drawback may be reduced stain repellency over time due to exposure to adverse environmental effects and washing. A second approach may be to repeatedly treat the fabric or fiber surface during the laundering or other fabric treatment process. With this approach, the stain repellency characteristics may be renewed with each treatment or after a specific time.

The lotus effect describes the observed super hydrophobic and self-cleaning property exhibited by the leaves of the lotus plant. Although lotuses tend to grow in muddy climates, the leaves exhibit a natural cleaning mechanism. The microscopic structure and surface chemistry of the leaves prevent them from being wetted by liquids having a contact angle of greater than 90° to an unstructured surface of the same material. Since water droplets may have a contact angle of up to 170°, the droplets roll off the leaf's surface, taking mud and other contaminants with them. Application of a similar structure to a fabric or fiber surface may enhance stain repellency.

For effective stain repellency, any fabric care composition must demonstrate complete and uniform coverage for the treated garment. Depositing a uniform layer of a stain repellency formulation onto a fabric or fiber surface presents various challenges and difficulties. Development of deposition aids which provide for uniform application of stain repellency formulations are required.

Consumers would benefit from fabrics with enhanced stain repellency, particularly for fabrics and garments that they currently own or are not fabricated from materials with inherent stain repellency characteristics. A fabric care composition that can be used to treat fabric, as a one-time treatment or with repeated treatments, and enhance the stain repellent characteristics of the fabrics would provide a benefit to consumers and other end users.

### SUMMARY OF INVENTION

The present disclosure relates to fabric care compositions for treating textiles. The treated textiles display improved stain repellency compared to textiles treated with conventional fabric care compositions.

According to one embodiment, the present disclosure provides a fabric care composition comprising an emulsion. The emulsion comprises a mixture comprising a hydrophobic fluid comprising silicone containing moieties or fluorine containing moieties, wherein the hydrophobic fluid is dispersible in water; and a particulate material having a particle size ranging from about 1 nm to about 10,000 nm; and an amphoteric or cationic oligomeric/polymeric deposition aid.

In another embodiment, the present disclosure provides a fabric care composition comprising a mixture comprising a hydrophobic fluid comprising silicone containing moieties or fluorine containing moieties, wherein the hydrophobic fluid is dispersible in water; and a particulate material having a particle size ranging from about 1 nm to about 10,000 nm; an amphoteric or cationic oligomeric/polymeric deposition aid; and a surfactant quencher.

In still another embodiment, the present disclosure provides a fabric care composition comprising a mixture comprising a hydrophobic fluid comprising silicone containing moieties or fluorine containing moieties, wherein the hydrophobic fluid is dispersible in water; and a particulate material having a particle size ranging from about 1 nm to about 10,000 nm; an amphoteric or cationic oligomeric/polymeric deposition aid; a surfactant quencher; and a dispersant aid selected from the group consisting of a non-ionic surfactant, a polymeric surfactant, a silicone-based surfactant, and combinations thereof.

In still another embodiment, the present disclosure provides a fabric care composition comprising a mixture comprising a hydrophobic fluid comprising silicone containing moieties or fluorine containing moieties, wherein the hydrophobic fluid is dispersible in water; and a particulate material having a particle size ranging from about 1 nm to about 10,000 nm; an amphoteric or cationic oligomeric/polymeric deposition aid; and a dispersant aid selected from the group consisting of a non-ionic surfactant, a polymeric surfactant, a silicone-based surfactant, and combinations thereof.

Still other embodiments of the present disclosure provide a method for providing improved stain repellency for a textile comprising treating a surface of a textile with a fabric care composition comprising an mixture comprising a hydrophobic fluid, a particulate material, an amphoteric or cationic oligomeric/polymeric deposition aid, and water, wherein the fabric care composition deposits on at least a portion of the textile fiber surface. The amphoteric or cationic oligomeric/polymeric deposition aid comprises a cationic polymer selected from the group consisting of a cationic polysaccharide, a cationic guar, a cationic lignin, a cationic polymer, an amine containing polymer, an amide containing polymer and combinations of any thereof.

### DETAILED DESCRIPTION OF THE INVENTION

### Definitions

As used herein, the term “stain repellency” means that the soil or staining materials do not form a strong attractive bond with the fabric or fiber surface and may readily be removed during the laundering process or other treatment process. As used herein, “stain repellency” may also include preventing the deposition of stain forming materials on a fabric or fiber surface, protecting the fabric or fiber surface from stain forming materials and release of a staining material from the surface of the fabric or fiber material.

As used herein the term “fabric care compositions” includes compositions and formulations designed for treating textiles and fabrics, such as, but not limited to, laundry cleaning compositions and detergents, laundry soap products, fabric softening compositions, fabric enhancing compositions, fabric freshening compositions, laundry prewash, laundry pretreat, laundry additives, spray products, and the like an may have a form selected from granular, powder, liquid (including heavy duty liquid (“HDL”) detergents), gels pastes, bar form, unit dose, and/or flake formulations, laundry detergent cleaning agents, laundry soak or spray treatments, and pre-treatments, fabric treatment compositions, dry cleaning agent or composition, laundry rinse additive, wash additive, post-rinse fabric treatment, ironing aid, unit dose formulation, delayed delivery formulation, and the like. Such compositions may be used as a pre-laundering treatment, a post-laundering treatment, or may be added during the rinse or wash cycle of the laundering operation.

As used herein, the term “comprising” means various components conjointly employed in the preparation of the composition or methods of the present disclosure. Accordingly, the terms “consisting essentially of” and “consisting of” are embodied in the term “comprising”.

As used herein, the articles including “the”, “a” and “an” when used in a claim or in the specification, are understood to mean one or more of what is claimed or described.

As used herein, the terms “include”, “includes” and “including” are meant to be non-limiting.

As used herein, the term “plurality” means more than one.

As used herein, the terms “fabric”, “textile”, and “cloth” are used non-specifically and may refer to any type of flexible material consisting of a network of natural or artificial fibers, including natural, artificial, and synthetic fibers, such as, but not limited to, cotton, linen, wool, polyester, nylon, silk, acrylic, and the like, including blends of various fabrics or fibers.

As used herein, the term “deposition aid” means a compound or composition that assists in deposition of a substance on a surface, such as the surface of a fabric or fiber during a treatment or laundering process. Deposition aids may allow for complete and uniform deposition of the substance on the fabric surface.

As used herein, the term “silicone” means a organic-inorganic man-made polymerized siloxanes or polysiloxane comprising primarily a silicon and oxygen backbone and having the general formula [R₂SiO]ₙ where R may be, for example, hydrogen, substituted or unsubstituted alkyl, —OH or alkoxy.

As used herein, the term “silicone resin” means a type of silicone material formed by branched, cage-like oligosiloxanes with the general formula RₙSiXₘO_{v/2}, where R is a non-reactive organic substituent and X is a functional group such as H, OH, Cl, or OR. The functional groups are condensed to give highly crosslinked, insoluble polysiloxane networks. For R=methyl, there are four possible functional siloxane monomeric units: “M”=Me₃SiO_{1/2}, “D”=Me₂SiO_{2/2}, “T”=MeSiO_{3/2}, and “Q”═SiO_{4/2}. Different silicone resins may be indicated by the primary units in their structure. For example, a M resin is made primarily of M units, an MQ resin is made primarily of M and Q units, and MDT resin is made primarily of M, D, and T units, etc.

As used herein, the term “surfactant quencher” means a compound or composition that binds to, or reacts with a surfactant to remove or otherwise deactivate unwanted surfactant in a mixture.

As used herein, the term “average molecular weight” refers to the average molecular weight of the polymer chains in a polymer composition. Average molecular weight may be calculated as either the weight average molecular weight (“M_{w}”) or the number average molecular weight (“Mₙ”). Weight average molecular weight may be calculated using the equation:

M_{w}=(ΣᵢNᵢMᵢ²)/(ΣᵢNᵢMᵢ)

where Nᵢ is the number of molecules having molecular weight M. Number average molecular weight may be calculated using the equation:

Mₙ=(ΣᵢNᵢMᵢ)/(ΣᵢNᵢ).

The weight and number average molecular weight may be measured according to gel permeation chromatography (“GPC”), size exclusion chromatography, or other analytical methods.

Unless otherwise noted, all component or composition levels are in reference to the active portion of that component or composition, and are exclusive of impurities, for example, residual solvents or by-products, which may be present in commercially available sources of such components or compositions.

All percentages and ratios are calculated by weight unless otherwise indicated. All percentages and ratios are calculated based on the total composition unless otherwise indicated.

It should be understood that every maximum numerical limitation given throughout this specification includes every lower numerical limitation, as if such lower numerical limitations were expressly written herein. Every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical ranges were all expressly written herein.

### Fabric Care Compositions

The present disclosure provides for fabric care compositions which provide improved stain repellency for fabrics treated with the fabric care composition. Improved stain repellency includes, for example, reduced binding of staining materials to the fabric or fiber surface such that the staining material is readily removed from the fabric or fiber surface using standard laundering protocols. The fabric care composition can be in the form of a single use composition (i.e., the fabric, garment or article may be treated once or at least infrequently to maintain the stain repellency character) or may be in the form of a multiple use composition (i.e., the fabric, garment, or article may be repeatedly treated with the composition to restore the stain repellency characteristics). When treated with the fabric care composition, the fabric or fiber surface may be coated with the stain repellent coating comprising a hydrophobic fluid and a particulate material.

Without being limited by any theory, the coating may provide an irregular hydrophobic surface, where the resulting coated stain repellent fabric has a coating comprising an emulsion of the hydrophobic fluid and particulate material. The particulate material and the hydrophobic fluid make a rough, irregular, or topographic coating on the fabric surface to which staining materials cannot effectively bind. For example, one potential mechanism preventing effective stain binding may be similar to the lotus effect. As used herein, the term “lotus effect” may include a super-hydrophobic and self-cleaning property such as is observed with the leaves of the lotus plant. According to this theory, microscopic structure and surface chemistry of the coated fabric prevent them from being wetted by liquids or staining materials having a contact angle of greater than 90° to an uncoated surface of the same material. As a result, liquids do not adhere to the coated surface and instead tend to bead up and roll off the surface, picking up and washing away debris and other materials from the fabric surface.

According to certain embodiments, the fabric care composition may comprise a suspension or an emulsion comprising a hydrophobic fluid comprising silicon containing moieties or fluorine containing moieties, a particulate material having a particle size ranging from about 1 nanometer (nm) to about 10,000 nm, and an amphoteric or cationic oligomeric or polymeric deposition aid. In specific embodiments, the fabric care composition may have a viscosity suitable to provide a uniform distribution during the laundry treatment process. For example, in certain embodiments, the viscosity of the fabric care composition may be less than 400 cP and in other embodiments, the viscosity may be less than 150 cP.

According to various embodiments, the hydrophobic fluid comprising silicon containing moieties or fluorine containing moieties may comprise one or more compounds selected from the group consisting of a fluoropolymer; polyorganosiloxane fluid compounds; a polysiloxane; an amino silicone; a polydialkyl siloxane; organofunctional silicones; cyclic silicones; cationic silicones; a silicone elastomer; a silicone polyether; a silicone quaternary compound; a silicone phosphate; a silicone betaine; a silicone amine oxide; an alkylated silicone; a fluorinated silicone; an alkylated silicone polyether; a silicone polyether ester or carboxylate; a reactive silicone comprising one or more alcohol, isocyanate, acrylate or vinyl group; an epoxy silicone; a silicone ester; a polyacrylate; a polymethacrylate; a polystyrene; a polyurethane; a polyester; a wax; and various combinations of any thereof. In various embodiments, the hydrophobic fluid may be a polyorganosiloxane fluid compound, such as a silicone, for example those disclosed in German Patent No. DE 10 2006 032,456.

In one embodiment, the hydrophobic fluid may be a polysiloxane fluid comprising about 50% to about 99.99% by weight of one or more polyorganosiloxanes fluid compounds, at least 0.01% by weight of one or more silicone resins, and water. The one or more polyorganosiloxanes fluid compounds may contain at least 80 mole % (mol %) of units having general formulas Ia, Ib, II, and III, below.

R¹₂SiO_{(2/2)} (Ia)

R¹ₐR²_{b}SiO_{(2/2)} (Ib)

R³₃SiO_{(1/2)} (II)

R³₂R⁴SiO_{(1/2)} (III)

Referring to formula I, “a” may have a value of 0, 1, or 2 and “b” may have a value of 1, or 2, provided that the sum of “a” and “b” equals 2 (i.e., a+b=2). According to one embodiments, each R¹ may independently be a hydrocarbon residue with from 1 to 40 carbon atoms and which may optionally be substituted with one or more halogens (such as —F, —Cl, and —Br). Hydrocarbon residues with from 1 to 40 carbon atoms include straight chained residues and branched residues. According to various embodiments, each R² may independently be an aminoalkyl residue having the general formula IV:

—R⁵—NR⁶R⁷. (IV)

According to formula IV, each R⁵ may independently be a divalent hydrocarbon residue with from 1 to 40 carbon atoms. Further, each R⁶ may independently be a monovalent hydrocarbon residue with from 1 to 40 carbon atoms, a hydrogen, a hydroxymethyl, or an alkanoyl residue (i.e., a —C(═O)—OR residue, where R is an hydrocarbon residue with from 1 to 40 carbon atoms, which may optionally be substituted with one or more halogens). Each R⁷ may independently be a residue having the general formula V:

—(R⁸—NR⁶)ₓ—R⁶, (V)

where “x” is an integer having a value ranging from 0 to 40; and each R⁸ may independently be a divalent residue having the general formula VI:

—(CR⁹₂)_{y}—, (VI)

where “y” is an integer having a value ranging from 1 to 6; and each R⁹ may independently be —H or a hydrocarbon residue with from 1 to 40 carbon atoms. Alternatively in formula IV, R⁶ and R⁷ together with the nitrogen atom may come together to form a cyclic organic residue with from 3 to 8 —CH₂— units and where nonadjacent —CH₂— units may optionally be replaced by a unit chosen from —C(═O)—, —NH—, —O—, and —S—. Referring to formulas II and III, each R³ may independently be a hydrocarbon residue with from 1 to 40 carbon atoms and which may optionally be substituted with one or more halogens (such as —F, —Cl, and —Br). Referring to formula III, each R⁴ may independently be —OR or —OH, where R is a hydrocarbon residue with from 1 to 40 carbon atoms and which may optionally be substituted with one or more halogens (such as —F, —Cl, and —Br).

According to embodiments of the polyorganosiloxane fluid compound, the ratio of units of formula Ito the sum of units of formulae II and III within the one or more polyorganosiloxane fluid compounds may range from about 0.5 to about 500, the average ratio of units of formula II to units of formula III within the one or more polyorganosiloxane fluid compounds may range from about 1.86 to about 100, and the one or more polyorganosiloxane fluid compounds may have an average amine number of at least about 0.01 meq/g of polyorganosiloxane fluid compound. In other embodiments, the average ratio of units of formula II to units of formula III within the one or more polyorganosiloxane fluid compounds may range from about 5 to 99, in certain cases from about 7 to 80, or from about 8 to 50 or even from about 10 to 30.

According to embodiments where the hydrophobic fluid is a polysiloxane fluid comprising 100 parts by weight of the polyorganosiloxanes fluid compounds as described herein, the fluid further comprises at least 0.01% by weight of one or more silicone resins, which may contain at least 80 mol % of units of general formulas VII, VIII, IX, and X:

R¹⁰₃SiO_{1/2} (VII)

R¹⁰₂SiO_{2/2} (VIII)

R¹⁰SiO_{3/2} (IX)

SiO_{4/2} (X)

where each R¹⁰ may independently be —H, —OH, —OR (where R is as defined above), or a hydrocarbon residue with from 1 to 40 carbon atoms and which may optionally be substituted with one or more halogens (such as —F, —Cl, and —Br). Further, for the various embodiments of the one or more silicone resins, at least about 20 mol % of the units may be selected from the group consisting of the general formulae IX and X and a maximum of 10 weight percent (wt %) of the R¹⁰ residues in the resins may be —OH or —OR residues. In other embodiments, a maximum of 3% or even 1% may be desired.

The silicone resins may preferably be MQ silicon resins (MQ) comprising at least 80 mol % of units, preferably at least 95 mol % and particularly at least 97 mol % of units of the general formulae VII and X. The average ratio of units of the general formulae VII to X is preferably at least 0.25, particularly at least 0.5, preferably at most 4, and more preferably at most 1.5.

The silicon resins may also preferably be DT silicone resins (DT) comprising at least 80 mol % of units, preferably at least 95 mol % and particularly at least 97 mol % of units of the general formulae VII and X. The average ratio of units of the general formulae VII to X is preferably at least 0.01, particularly at least 0.2, preferably at most 3.5, and more preferably at most 0.5.

Further, according to embodiments where the hydrophobic fluid is a polysiloxane fluid comprising 100 parts by weight of the one or more polyorganosiloxane fluid compounds, the fluid further comprises water. Water used in the various embodiments of the hydrophobic fluids may include water that is completely demineralized water or water that contains various concentrations of salts (inorganic salts and/or organic salts). Preferred embodiments include completely demineralized water. In one embodiment the hydrophobic fluid may comprise a maximum of 5 parts by weight of water. In other embodiments where the hydrophobic fluid is an emulsion, the fluid may comprise at least 5 parts by weight of water and in preferred embodiments at least 10 parts by weight of water and, optionally, less than 5 parts by weight of an emulsifier.

The monovalent hydrocarbon residues R, R¹, R³, R⁶, R⁹, and R¹⁰ may independently be halogen substituted (as described above, preferably —F, and —Cl), linear, cyclic, branched, aromatic, saturated, or unsaturated. In specific embodiments, the monovalent hydrocarbon residues R, R¹, R³, R⁶, R⁹, and R¹⁰ may independently have from 1 to 6 carbon atoms, which in particular embodiments may be alkyl residues and phenyl residues. In particular embodiments, the monovalent hydrocarbon residues R, R¹, R³, R⁶, R⁹, and R¹⁰ may independently be methyl, ethyl, or phenyl.

The divalent hydrocarbon residues R⁵ may independently be halogen substituted (as described above, preferably —F, and —Cl), linear, cyclic, branched, aromatic, saturated, or unsaturated. In specific embodiments, the R⁵ residues may independently have from 1 to 10 carbon atoms or even may be a 1 to 6 carbon atom alkylene residue, such as, for example, a propylene residue.

Referring to the R⁶ residues, according to various embodiments the R⁶ residues may independently be alkyl and alkanoyl residues with preferred halogen substitution including —F and —Cl. In specific embodiments, where the R⁶ residue is alkanoyl, the alkanoyl may have the general formula —C(═O)—OR¹¹, where R¹¹ is a hydrocarbon residue having from 1 to 40 carbon atoms and which may optionally be substituted with one or more halogens. In particular embodiments, each R⁶ residue may independently be methyl, ethyl, cyclohexyl, acetyl, or —H.

According to certain embodiments where the R⁶ and R⁷ form a cyclic residue with the nitrogen atom, the cyclic residue may include pentacycles and hexacycles, such as, but not limited to, residues of pyrrolidine, pyrrolidino-2-one, pyrrolidino-2,4-dione, pyrrolidino-3-one, pyrazol-3-one, oxazolidine, oxazolidin-2-one, thiazolidine, thiazolidin-2-one, piperidino, piperazine, piperazine-2,5-one, and morpholine.

In specific embodiments, the R² residues may independently have a structure such as —CH₂NR⁶R⁷, —(CH₂)₃NR⁶R⁷, or —(CH₂)₃N(R⁶)((CH₂)₂N(R⁶)₂); and in particular embodiments, the R² residues may independently be aminoethylaminopropyl and/or cyclohexylaminopropyl residues.

Referring still to the one or more polyorganosiloxane fluid compounds, according to certain embodiments of formula I the value of “b” may be 1 or 2 and in particular embodiments, the sum of a+b may have an average value of 1.9-2.2. In certain embodiments of formula V, the value of “x” may be 0 or may range from 1 to 18, and preferably from 1 to 6. In certain embodiments of formula VI, the value of “y” may be 1, 2, or 3. In preferred embodiments of the polyorganosiloxane fluid, the polyorganosiloxane may contain at least 3 and in specific embodiments at least 10 units having the general formula I.

According to various embodiments of the polyorganosiloxanes having aminoalkyl groups, the ratio of units according to formula I to the sum of units of formulae II and III is from 0.5 to 500, the ratio of units of formula II to units of formula III is from 1.86 to 100, and the polyorganosiloxanes may have an amine number of at least 0.01 meq/g of the polyorganosiloxane or in specific embodiments at least 0.1 meq/g, and some at least 0.3 meq/g of the polyorganosiloxane. Some embodiments may have the amine number of the polyorganosiloxane fluid as being a maximum of about 7 meq/g. Others may have a maximum of about 4.0 meq/g, and yet others may have a maximum of 3.0 meq/g polyorganosiloxane fluid. In specific embodiments, the ratio of the units of formula I to the sum of units of formula II and III may be at least 10 or even at least 50 and a maximum or 250 or even a maximum of 150. Further, in other embodiments, the ratio of the units II to III may be at least 3 or even at least 6 and a maximum of 70 or even a maximum of 50.

The viscosity of the polyorganosiloxane fluids (at 25° C.) according to various embodiments may be at least 1 mPa·s and in specific embodiments at least 10 mPa·s. In certain embodiments the viscosity may have a maximum value of 100,000 mPa·s, or even a maximum of 10,000 mPa·s.

Referring to the one or more silicone resins (for example an MQ resin) of the embodiments of the hydrophobic fluid described herein, certain embodiments of the hydrophobic fluid may comprise at least 0.01% by weight, or 2% by weight or even at least 4.7% by weight of the one or more silicone resins. Various embodiments of the hydrophobic fluid may comprise a maximum of 90 parts by weight or 50 parts by weight or even a maximum of 30 parts by weight of the silicone resin. In specific embodiments, the hydrophobic fluid may comprise a maximum of 17% by weight of the silicone resin and in particular embodiments a maximum of 10% by weight of the silicone resin. Specific embodiments of the silicone resins may comprise at least 95 mol % of units of general formulae VII and X. According to various embodiments, the ratio of the units of general formula VII to units of general formula X may be a maximum of 2.5 or, in certain embodiments a maximum of 1.5. Specific embodiments of the hydrophobic fluids may have silicone resins where a maximum of 2.5% of the R¹⁰ residues are chosen from —OR and —OH.

In certain embodiments, the MQ silicone resins may additionally contain other silicone units such as, for example, units having the general formulas of VIII and/or IX.

R¹⁰₂SiO_{2/2} (VIII)

R¹⁰SiO_{3/2} (IX)

where R¹⁰ is as described herein. In other embodiments, at least about 20 mol % of the units may be selected from the group consisting of units of general formulae IX and X.

According to certain embodiments, the hydrophobic fluid may further comprise one or more organic solvents, such as, but not limited to, mono- or polyalcohols, for example methanol, ethanol, n-propanol, isopropanol, butanol, n-amylalcohol, i-amylalcohol, diethylene glycol and glycerols; and mono- or polyethers, for example, dioxane, tetrahydrofuran, diethyl ether, diisopropyl ether, propylene glycol, ethylene glycol monobutyl ether, ethylene glycol monohexyl ether, ethylene glycol monomethyl ether, ethylene glycol monoethyl ether, diethylene glycol dimethyl ether, and diethylene glycol diethyl ether. Suitable mono- or polyalcohols and their ethers for solvents according to certain embodiments may have a boiling point or boiling range of a maximum of 260° C. at 0.1 MPa.

Referring to the particulate materials of the emulsion, various embodiments of the particulate material may comprise an inelastic solid particulate and/or an elastic solid particulate. Particulates refer to relatively small, solid particles having a form such as a granule, pulverulents, spheres, aggregates, agglomerates, and combinations thereof. Particulates may have any shape or combination of shapes, for example, cubic, rod-like, polyhedral, spherical, rounded, angular, irregular, needle-like, flake-like, fiber-like, or rod-like randomly-sized irregular shapes. Particulates may be formed from organic materials, inorganic materials, or a combination of organic and inorganic materials and may be natural, synthetic or semi-synthetic. The particulates may have surface charges or the surface can be modified with organic or inorganic materials, such as surfactants, polymers, and other inorganic materials. The surface of the particulate material may be charged through a static development or with the attachment of various ionic groups directly or linked via a short, long or branched alkyl group to the material surface. The surface charge or the particulate material may be anionic, cationic, zwitterionic, or amphoteric in nature.

Suitable inelastic solid particulates include, for example, silicates, including synthetic silicates, such as synthetic layered silicate LAPONITE® additives (commercially available from Southern Clay Products, Gonzales, Tex., USA), multilayered titania, silica, colloidal silica, polyethylene oxide-LAPONITE®, clay, aluminum, metal oxide particles, and various polymer-clay particles. Suitable elastic solid particulates include, for example, silicone resin particulates, such as, but not limited to, silsesquioxane polymer particulate, an M resin particulates, a Q resin particulates, a T resin particulates, a D resin particulates, an MQ resin particulates, TQ resin particulates and various mixtures of any thereof. According to specific embodiments, the elastic solid particulate may be an MQ silicone resin particulate, a TQ silicone resin particulate, or a mixture thereof. Other examples of elastic solid particulates may include other polymer particles, such as, polymethylmethacrylate particles, polystyrene particles, and various copolymer particles. In those embodiments comprising inelastic solid particulates, the inelastic solid particulates may have an average particle size ranging from about 5 nm to about 10,000 nm, or even an average particle size ranging from about 5 nm to 1,000 nm. In those embodiments comprising elastic solid particulates, the elastic solid particulates may have an average particle size ranging from about 1 nm to about 10,000 nm, or even an average particle size ranging from about 5 nm to about 200 nm.

The hydrophobic fluid and the particulate material of the various aspects of the present disclosure may be in the form of a suspension or an emulsion. In specific embodiments, the hydrophobic fluid and the particulate material are in the form of an emulsion. Various embodiments of the emulsion may comprise one or more emulsifiers. Suitable emulsifiers include, for example, hexyl glycol (2-hexoxyethanol); anionic surfactants, such as sodium lauryl sulfate (SLS) and linear alkylbenzene sulfonate (LAS); cationic surfactants, such as amine surfactants and amide surfactants; nonionic surfactants, such as amine oxides and ethylene oxide series. Other suitable emulsifiers may be found, for example, in “McCutcheon's: Emulsifiers and Detergents International Edition,” M. Allured ed., McCutcheon Publications.

Still other examples of emulsifiers may include sorbitan esters of fatty acids having 10 to 22 carbon atoms; polyoxyethylene sorbitan esters of fatty acids having 10 to 22 carbon atoms and an ethylene oxide content of up to 35 percent; polyoxyethylene sorbitan esters of fatty acids having 10 to 22 carbon atoms; polyoxyethylene derivatives of phenols having 6 to 20 carbon atoms on the aromatic and an ethylene oxide content of up to 95 percent; fatty amino- and amidobetaines having 10 to 22 carbon atoms; polyoxyethylene condensates of fatty acids or fatty alcohols having 8 to 22 carbon atoms with an ethylene oxide content of up to 95 percent; fatty amine oxides having 10 to 22 carbon atoms; fatty imidazolines having 6 to 20 carbon atoms; fatty amidosulfobetaines having 10 to 22 carbon atoms; quarternary emulsifiers, such as fatty ammonium compounds having 10 to 22 carbon atoms; fatty morpholine oxides having 10 to 22 carbon atoms; alkali metal salts of carboxylated, ethoxylated alcohols having 10 to 22 carbon atoms and up to 95 percent of ethylene oxide; ethylene oxide condensates of fatty acid monoesters of glycerol having 10 to 22 carbon atoms and up to 95 percent of ethylene oxide; mono- and diethanolamides of fatty acids having 10 to 22 carbon atoms; phosphate esters.

It is well known in the area of emulsifiers, the opposition ions in the case of cationic emulsifiers, the opposition ion is a halide, sulfate or methylsulfate. Chlorides are the most industrially available compounds.

The abovementioned fatty structures are usually the lipophilic half of the emulsifiers. A customary fatty group is an alkyl group of natural or synthetic origin. Known unsaturated groups are the oleyl, linoleyl, decenyl, hexadecenyl and dodecenyl radicals. Alkyl groups may be cyclic, linear or branched. Other possible emulsifiers are sorbitol monolaurate/ethylene oxide condensates; sorbitol monomyristate/ethylene oxide condensates; sorbitol monostearate/ethylene oxide condensates; dodecylphenol/ethylene oxide condensates; myristylphenol/ethylene oxide condensates; octylphenyl/ethylene oxide condensates; stearylphenol ethylene oxide condensates; lauryl alcohol/ethylene oxide condensates; stearyl alcohol/ethylene oxide condensates; decylaminobetaine; cocoamidosulfobetaine; olylamidobetaine; cocoimidazoline; cocosulfoimidazoline; cetylimidazoline; 1-hydroxyethyl-2-heptadecenylimidazoline; n-cocomorpholine oxide; decyldimethylamine oxide; cocoamidodimethylamine oxide; sorbitan tristearate having condensed ethylene oxide groups; sorbitan trioleate having condensed ethylene oxide groups; trimethyldodecylammonium chloride; trimethylstearylammonium methosulfate.

Specific embodiments may further comprise one or more neutralizing agents, such as an acidic agent to lower the pH of the fabric care composition. Examples of suitable neutralizing agents include inorganic and organic acids, such as, for example, HCl, HNO₃, H₂SO₄, acetic acid and the like.

The optional emulsifier may also comprise protective colloids. Suitable protective colloids (PC) are polyvinyl alcohols; polyvinyl acetals; polyvinylpyrrolidones; polysaccharides in water-soluble form, such as starches (amylose and amylopectin), celluloses and the carboxymethyl, methyl, hydroxyethyl and hydroxypropyl derivatives thereof, dextrins and cyclodextrins; proteins, such as casein or caseinate, soybean protein, gelatin; ligninsulfonates; synthetic polymers, such as poly(meth)acrylic acid, copolymers of (meth)acrylates with carboxy-functional comonomer units, poly(meth)acrylamide, polyvinylsulfonic acids and the water-soluble copolymers thereof; melamine formaldehyde sulfonates, naphthalene formaldehyde sulfonates, styrene-maleic acid and vinyl ether-maleic acid copolymers; cationic polymers, such as poly-DADMAC.

Partly hydrolyzed or completely hydrolyzed polyvinyl alcohols having a degree of hydrolysis of from 80 to 100 mol %, in particular partly hydrolyzed polyvinyl alcohols having a degree of hydrolysis of from 80 to 95 mol % are preferred. Examples of these are partly hydrolyzed copolymers of vinyl acetate with hydrophobic comonomers, such as isopropenyl acetate, vinyl pivalate, vinyl ethylhexanoate, vinyl esters of saturated alpha-branched monocarboxylic acids having 5 or 9 to 11 C atoms, dialkyl maleates and dialkyl fumarates, such as diisopropyl maleate and diisopropyl fumarate, vinyl chloride, vinyl alkyl ethers, such as vinyl butyl ether, olefins, such as ethene and decene. Examples of such vinyl esters are those which are offered as vinyl versatate under the designations Veo Va®5, Veo Va®9, Veo Va®10 and Veo Va®11. The proportion of the hydrophobic units is preferably from 0.1 to 10% by weight, based on the total weight of the partly hydrolyzed polyvinyl alcohol. It is also possible to use mixtures of said polyvinyl alcohols.

Further polyvinyl alcohols which are most preferred are partly hydrolyzed, hydrophobized polyvinyl acetates which are obtained by polymer-analogous reaction, for example acetalation of the vinyl alcohol units with C₁- to C₄-aldehydes, such as butyraldehyde. The proportion of the hydrophobic units is preferably from 0.1 to 10% by weight, based on the total weight of the partly hydrolyzed polyvinyl acetate. The degree of hydrolysis is from 80 to 95 mol %, preferably from 85 to 94 mol %. Said protective colloids (PC) are obtainable by means of processes known to the person skilled in the art.

The mixtures (M) preferably include at most 50 parts by weight and particularly at most 30 parts by weight and preferably at least 0.1% by weight of such protective colloids (PC).

In particular embodiments of the fabric care compositions, the hydrophobic fluid and the particulate materials, such as those hydrophobic fluids and particulate materials described herein, may be capable of forming cross-links. That is, a plurality of cross-linking interactions, such as, but not limited to, a cross-linking interaction selected from a covalent bond, a polar-covalent bond, or a non-covalent bond or interaction (including ionic bonds, hydrogen bonds, and van der Waals type interactions), may be formed between the particulate material and the hydrophobic fluid. For example in one embodiment, a plurality of cross-links may be formed between the polyorganosiloxane having aminoalkyl groups and the silicone resin particulate material.

According to certain embodiments of the fabric care compositions of the present disclosure, the emulsion or suspension comprising the hydrophobic fluid and the particulate material may further comprise a solvent. In one embodiment, the solvent may be water. In other embodiments, the solvent may be an organic solvent, such as those described herein, including mono- and polyalcohols and mono- and polyethers.

### Deposition Aid

Referring now to the cationic or amphoteric oligomeric/polymeric deposition aid, the deposition aid may be capable of providing efficient and uniform deposition of the hydrophobic fluid and the particulate material on at least a portion of the surface of the fabric or fiber. As used herein, the term “uniform” means that the composition of the layer of the hydrophobic fluid and particulate material on one section of the fabric or fiber is substantially the same as other sections of the fabric or fiber. The deposition aid of the present disclosure may be a cationic or amphoteric oligomer or polymer or a combination or blend of cationic and/or amphoteric oligomers and/or polymers that enhance the deposition of the fabric care composition onto the surface of the fabric or fiber during the treatment process. Without wishing to be bound by any theory, it is believed that in order to drive the fabric care agent onto the surface of the fabric, the net charge of the deposition aid, such as a positive net charge, may be used to overcome repulsive interactions between the fabric care agent and the fabric surface. For example, many fabrics (such as cotton, rayon, silk, wool, etc.) are comprised of fibers that may have a slightly negative charge in aqueous environment. In certain embodiments, an effective amphoteric or cationic oligomeric/polymeric deposition aid may be characterized by a strong binding capability with the present fabric care agents and compositions via physical forces, such as, van der Waals forces, and/or non-covalent chemical binds such as hydrogen bonding and/or ionic bonding. In some embodiments, the deposition aids may also have a strong affinity to natural fabric fibers, such as cotton or wool fibers.

In particular embodiments, the deposition aids described herein are water soluble and may have flexible molecular structures such that they may associate with the surface of a fabric care agent particle or hold several of the particles together. Therefore, the deposition enhancing agent may typically not be cross-linked and typically does not have a network structure.

According to certain embodiments of the fabric care compositions of the present disclosure, the amphoteric or cationic oligomeric/polymeric deposition aid may be a cationic polymer selected from the group consisting of a cationic polysaccharide, a cationic guar, a cationic lignin, a cationic polymer, an amine containing polymer, an amide containing polymer, and combinations of any thereof. The term “cationic polymer” refers to a polymer having a net cationic charge. Polymers containing amine groups or other protonatable groups are included in the term “cationic polymer,” wherein the polymer is protonated at the pH of intended use. In specific embodiments, the cationic polymer may be a branched cationic polymer. For example, according to certain embodiments, the cationic polymer may be a branched cationic polysaccharide, wherein the polysaccharide has a fraction of alpha-1,4-glycosidic linkages of at least about 0.01 up to about 1.0.

In another aspect, the fabric care composition and/or treatment composition may comprise a deposition aid selected from the group consisting of cationic or amphoteric polysaccharides. Suitable cationic polysaccharides for the various embodiments of the deposition aids described herein include, but are not limited to, cationic cellulose derivatives, cationic and amphoteric cellulose ethers, cationic or amphoteric galactomannan, cationic guar gum derivatives, cationic or amphoteric starches and derivatives, and cationic chitosan and derivatives. In specific embodiments, the branched cationic polysaccharides may be a branched cationic starch. For example, according to one embodiment, the branched cationic starch may comprise amylase, preferably a branched cationic starch will comprise more than 20% amylase.

In some embodiments, the cationic polysaccharide deposition aid may be a cationic guar derivative having a general formula (A):

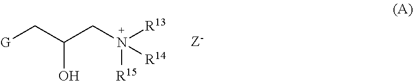

where G is a galactomannan backbone; R¹³ is a group selected from CH₃, CH₂CH₃, phenyl, a C₈-C₂₄ alkyl group (linear or branched) and combinations thereof; R¹⁴ and R¹⁵ are groups independently selected from CH₃, CH₂CH₃, phenyl, and combinations thereof; and Z⁻ is a suitable anion. In certain embodiments, the guar derivatives include guar hydroxypropyl trimethyl ammonium chloride. Examples of cationic guar gums are Jaguar™ C13 and Jaguar™ Excel, available from Rhodia, Inc. (Cranberry, N.J.).

In one aspect, the fabric care and/or treatment composition may comprise from about 0.01% to about 10%, or from about 0.05 to about 5%, or from about 0.1 to about 3% of the deposition aid. Suitable deposition aids are disclosed in, for example, U.S. application Ser. No. 12/080,358.

In one aspect, the one or more deposition aids may be a cationic polymer. In one aspect, the deposition aid may comprise a cationic polymer having a cationic charge density of from about 0.1 meq/g to about 23 meq/g from about 0.1 meq/g to about 12 meq/g, or from about 0.3 meq/g to about 7 meq/g, at the pH of intended use of the composition. For amine-containing polymers, wherein the charge density depends on the pH of the composition, charge density is measured at the pH of the intended use of the product. Such pH will generally range from about 2 to about 11, more generally from about 2.5 to about 9.5. Charge density is calculated by dividing the number of net charges per repeating unit by the molecular weight of the repeating unit. The positive charges may be located on the backbone of the polymers and/or the side chains of polymers. For example, for the copolymer of acrylamide and diallyldimethylammonium chloride with a monomer feed ratio of 70:30, the charge density of the feed monomers is about 3.05 meq/g. However, if only 50% of diallyldimethylammonium is polymerized, the polymer charge density is only about 1.6 meq/g. The polymer charge density may be measured by dialyzing the polymer with a dialysis membrane or by NMR. For polymers with amine monomers, the charge density depends on the pH of the carrier. For these polymers, charge density is measured at a pH of 7.

In one aspect, the cleaning and/or treatment composition may comprise an amphoteric deposition aid polymer so long as the polymer possesses a net positive charge. The polymer may have a cationic charge density of from about 0.05 meq/g to about 12 meq/g.

Suitable polymers may be selected from the group consisting of cationic or amphoteric polysaccharides, polyethylene imine and its derivatives, and a synthetic polymer made by polymerizing one or more cationic monomers selected from the group consisting of N,N-dialkylaminoalkyl acrylate, N,N-dialkylaminoalkyl methacrylate, N,N-dialkylamino alkyl acrylamide, N,N-dialkylaminoalkylmethacrylamide, quaternized N,N dialkylamino alkyl acrylate, quaternized N,N-dialkylaminoalkyl methacrylate, quaternized N,N-dialkylaminoalkyl acrylamide, quaternized N,N-dialkylaminoalkylmethacrylamide, methacryloamidopropyl-pentamethyl-1,3-propylene-2-ol-ammonium dichloride, N,N,N,N′,N′,N″,N″-heptamethyl-N″-3-(1-oxo-2-methyl-2-propenyl)aminopropyl-9-oxo-8-azo-decane-1,4,10-triammonium trichloride, vinylamine and its derivatives, allylamine and its derivatives, vinyl imidazole, quaternized vinyl imidazole and diallyl dialkyl ammonium chloride and combinations thereof, and optionally a second monomer selected from the group consisting of acrylamide, N,N-dialkyl acrylamide, methacrylamide, N,N-dialkyl methacrylamide, C₁-C₁₂ alkyl acrylate, C₁-C₁₂ hydroxyalkyl acrylate, polyalkylene glyol acrylate, C₁-C₁₂ alkyl methacrylate, C₁-C₁₂ hydroxyalkyl methacrylate, polyalkylene glycol methacrylate, vinyl acetate, vinyl alcohol, vinyl formamide, vinyl acetamide, vinyl alkyl ether, vinyl pyridine, vinyl pyrrolidone, vinyl imidazole, vinyl caprolactam, and derivatives, acrylic acid, methacrylic acid, maleic acid, vinyl sulfonic acid, styrene sulfonic acid, acrylamidopropylmethane sulfonic acid (AMPS) and their salts. The polymer may optionally be branched or cross-linked by using branching and crosslinking monomers. Branching and cros slinking monomers include ethylene glycoldiacrylate divinylbenzene, and butadiene. A suitable polyethyleneinine useful herein is that sold under the trade name Lupasol® by BASF, AG, Lugwigshafen, Germany.

In another aspect, the deposition aid may be selected from the group consisting of cationic polysaccharides, cationic hydroxy ethyl cellulose (such as Cat HEC polymer PK having a molecular weight of about 400,000 Daltons and a charge density of 1.25 meq/g, commercially available from Dow Chemical, Midland Mich.), cationic starches (such as Akzo, EXP 5617-2301-28 (National Starch 126290-82), available from National Starch, Bridgewater, N.J.), polyethylene imine and its derivatives, poly(acrylamide-co-diallyldimethylammonium chloride), poly(acrylamide-methacrylamidopropyltrimethyl ammonium chloride), poly(acrylamide-co-N,N-dimethyl aminoethyl acrylate) and its quaternized derivatives, poly(acrylamide-co-N,N-dimethyl aminoethyl methacrylate) and its quaternized derivative, poly(hydroxyethylacrylate-co-dimethyl aminoethyl methacrylate), poly(hydroxpropylacrylate-co-dimethyl aminoethyl methacrylate), poly(hydroxpropyl acrylate-co-methacrylamidoprop yltrimethylammonium chloride), poly(acrylamide-co-diallyldimethylammonium chloride-co-acrylic acid), poly(acrylamide-methacrylamido propyltrimethyl ammonium chloride-co-acrylic acid), poly(diallyldimethyl ammonium chloride) (such as that sold under trade names: Merquat® 100 and having a molecular weight of 150,000 Daltons, commercially available from Nalco Co., Naperville, Ill.), poly(vinylpyrrolidone-co-dimethylaminoethyl methacrylate), poly(ethyl methacrylate-co-quaternized dimethylaminoethyl methacrylate), poly(ethyl methacrylate-co-oleyl methacrylate-co-diethylaminoethyl methacrylate), poly(diallyldimethylammonium chloride-co-acrylic acid), poly(vinyl pyrrolidone-co-quaternized vinyl imidazole) and poly(acrylamide-co-methacryloamidopropyl-pentamethyl-1,3-propylene-2-ol-ammonium dichloride). In a specific embodiment, the deposition aid may be a terpolymer with a mole ration of 90% polyacrylamide: 5% acrylic acid: 5% methylenebis-acrylamide-methacrylamido-propyl trimethylammonium chloride (“MAPTAC”, sold under the trade names TX12528SQ, or Merquat® 5300, commercially available from Nalco Co, Naperville, Ill.). Suitable deposition aids include Polyquaternium-1, Polyquaternium-5, Polyquaternium-6, Polyquaternium-7, Polyquaternium-8, Polyquaternium-11, Polyquaternium-14, Polyquaternium-22, Polyquaternium-28, Polyquaternium-30, Polyquaternium-32 and Polyquaternium-33, as named under the International Nomenclature for Cosmetic Ingredients.

In one aspect, the deposition aid may comprise polyethyleneimine or a polyethyleneimine derivative. In another aspect, the deposition aid may comprise a cationic acrylic based polymer. In another aspect, the deposition aid may comprise a cationic polyacrylamide. In another aspect, the deposition aid may comprise a polymer comprising polyacrylamide and polymethacrylamidoproply trimethylammonium cation. In another aspect, the deposition aid may comprise poly(acrylamide-N,N-dimethylaminoethyl acrylate) and its quaternized derivatives. In this aspect, the deposition aid may be that sold under the trade name Sedipur®, available from BTC Specialty Chemicals, a BASF Group, Florham Park, N.J. In another aspect, the deposition aid may comprise poly(acrylamide-co-methacrylamidopropyltrimethyl ammonium chloride). In another aspect, the deposition aid may be a non-acrylamide based polymer, such as that sold under the trade name Rheovis® CDE, available from Ciba Specialty Chemicals, a BASF group, Florham Park, N.J., or as disclosed in U.S. Published Application No. 2006/0252668.

Another group of suitable cationic polymers may include alkylamine-epichlorohydrin polymers which are reaction products of amines and oligoamines with epicholorohydrin, for example, those polymers listed in, for example, U.S. Pat. Nos. 6,642,200 and 6,551,986. Examples include dimethylamine-epichlorohydrin-ethylenediamine, available under the trade name Cartafix® CB and Cartafix® TSF from Clariant, Base1, Switzerland.

Another group of suitable synthetic cationic polymers may include polyamidoamine-epichlorohydrin (PAE) resins of polyalkylenepolyamine with polycarboxylic acid. The common PAE resins may include the condensation products of diethylenetriamine with adipic acid followed by a subsequent reaction with epichlorohydrin. Suitable examples are available from Hercules Inc. of Wilmington Del. under the trade name Kymene™ or from BASF AG (Ludwigshafen, Germany) under the trade name Luresin™. These polymers are described in “Wet Strength Resins and their Applications,” edited by L. L. Chan, TAPPI Press (1994).

In various embodiments, the weight-average molecular weight of the oligomeric/polymeric deposition aids may range from about 500 to about 10,000,000, from about 1,000 to about 5,000,000, or from about 10,000 to about 5,000,000 Daltons, as determined by size exclusion chromatography relative to polyethyleneoxide standards with RI detection. In one aspect, the MW of the cationic polymer may be from about 50,000 to about 3,000,000 Daltons.

The cationic polymers may contain charge neutralizing anions such that the overall polymer is neutral under ambient conditions. Non-limiting examples of suitable counter ions (in addition to anionic species generated during use) include chloride, bromide, sulfate, methylsulfate, sulfonate, methylsulfonate, carbonate, bicarbonate, formate, acetate, citrate, nitrate, and mixtures thereof.

Useful cationic polysaccharides, such as the branched cationic polysaccharides, such as the branched cationic starches, described herein may have at least one of a viscosity of less than about 1000 centipoise (cP), a charge density ranging from about 0.001 milliequivalents per gram (meq/g) of the polymer to about 5.0 meq/g of the polymer, and a weight average molecular weight ranging from about 500 Daltons to about 10,000,000 Daltons. In one embodiment, the deposition aid may be a cationic starch (such as Akzo, EXP 5617-2301-28 (National Starch 126290-82), available from National Starch, Bridgewater, N.J.) having a structure XI:

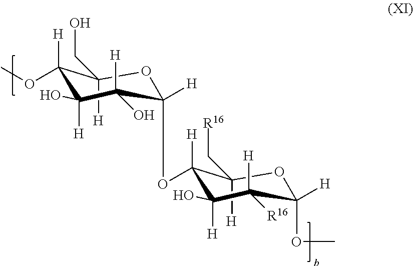

where R¹⁶ may be —OH or —(O)ₚ—(CH₂)ₙ(CH(OH))ₘCH²N⁺(CH₃)₃ where p is 0 or 1, n is 1-10 and m is 0 or 1, provided that at least one R¹⁶ group per substituted glucose unit is not —OH, and having a suitable counteranion, charge density of from about 0.35 meq/g to about 0.6 meq/g, an amylose content of about 28%, a water fluidity (WF) of from about 62 to about 70, and a molecular weight of from about 1,200,000 Daltons to about 3,000,000 Daltons. In one specific embodiment, the starch may be derived from maize, and modified with R¹⁶ where —O—CH₂CH(OH)ₘCH₂N⁺(CH₃)₃, and the charge density may be about 0.42 meq/g, the molecular weight may be about 1,500,000 Daltons, and the amylose content may be about 28%.

As used herein, the charge density of the cationic or amphoteric polymers means the measurement of the charge of a polymer (measured in meq) per gram of the polymer and may be calculated, for example, by dividing the number of net charges per repeating unit by the molecular weight of the repeating unit. As recited above, in one embodiment, the charge density of the deposition aid may range from about 0.001 meq/g to about 5.0 meq/g of polymer. In another embodiment, the charge density of the deposition aid may range from about 0.1 meq/g to about 3.0 meq/g of polymer. According to the various embodiments, the charges, for example, the positive charges, may be located on the backbone of the polymer and/or on a side chain of the polymer.

Other embodiments of the branched cationic polysaccharides may have a weight average molecular weight ranging from about 50,000 Daltons to about 10,000,000 Daltons, or even from about 100,000 Daltons to about 5,000,000 Daltons. Certain embodiments of branched cationic celluloses (including cationic hydroxyethyl cellulose) may have a weight average molecular weight ranging from about 200,000 Daltons to about 3,000,000 Daltons and certain embodiments of the cationic guars may have a weight average molecular weight ranging from about 500,000 Daltons to about 2,000,000 Daltons.

Other branched cationic polymers can include branched cationic lignins and branched cationic synthetic polymers. Branched cationic lignins include lignin structures, such as, but not limited to lignin sulfonates, Kraft lignins, soda lignins, organosolv lignins, softwood lignin, hardwood lignin, steam explosion lignins, cellulosic grasses lignins, corn stover lignins, and combinations of any thereof, that have been modified to have cationic substituents, such as quaternary ammonium containing substituents. Modifying the lignin polymer may include, for example, substituting one or more of the hydroxyl groups on a lignin polymer backbone with one or more R substituent groups having a cationic charge, such as a quaternary ammonium charged group. In other embodiments, modifying the lignin polymer may include substituting at least one of the hydroxy, methoxy or aromatic carbons on the lignin polymer backbone with at least one R substituent group having a cationic charge.

The synthetic cationic or amphoteric oligomeric/polymeric deposition aids may be random, block or grafted copolymers and may be linear or branched. Certain embodiments of the synthetic oligomeric/polymeric deposition aid may have a weight average molecular weight ranging from about 2,000 Daltons to about 10,000,000 Daltons, or in specific embodiments from about 10,000, Daltons to about 3,000,000 Daltons or even ranging from about 500,000 Daltons to about 2,000,000 Daltons.

According to certain embodiments, the fabric care composition may be any common composition for treating fabrics, including, but are not limited to, detergents, liquid laundry detergents, heavy duty liquid laundry detergents, solid laundry detergents, powder detergents, laundry soap products, laundry spray treatment products, laundry pre-treatment products, laundry soak products, heavy duty liquid detergents, laundry rinse additives, wash additives, fabric enhancers, laundry spray treatments, post-rinse fabric treatments, ironing aids, unit dose, formulations, dry cleaning compositions, delayed delivery formulations, and various combinations of any thereof.

In various embodiments, the fabric care compositions described herein may further comprise at least one or more additive or adjunct. Suitable additives or adjuncts include, but are not limited to, a bleach, bleach activators, surfactants, builders, chelating agents, dye transfer inhibiting agents, dispersants, enzymes, enzyme stabilizers, catalytic metal complexes, polymeric dispersing agents, clay and soil removal/anti-redeposition agents, brighteners, suds suppressors, suds enhancers, dyes, perfumes, perfume delivery systems, structure elasticizing agents, fabric softeners, carriers, hydrotropes, solvents, processing aids, and pigments. Various additives and adjuncts are described in detail elsewhere herein.

Further embodiments of the fabric care compositions described herein may further comprise a dispersant. As used herein, a dispersant is a chemical compound or compounds that are used to stabilize an emulsion, dispersion or suspension of particles in a liquid. Suitable dispersants for use in the various embodiments described herein include non-ionic surfactants, polymeric surfactants, and silicone based dispersants. According to various embodiments, the dispersant may comprise from about 0.001% to 5% by weight of the composition; in certain embodiments from 0.05% to 2% by weight of the composition and in specific embodiments from 0.05%-0.5% by weight of the composition.

For example, suitable non-ionic surfactant include, but are not limited to, ethoxylated alcohols (aliphatic ethoxylate), polyethylene oxide (PEO) caprilic acid, PEO stearic acid, PEO oleic acid, PEO Lauric acid, nonionic hydroxylamines, ethoxylated alkylphenols, fatty esters, proxylated & ethoxylated fatty acids, alcohols, or alkyl phenols, fatty esters series, ethoxylated fatty acids, Ethoxylated fatty esters and oils, alkanolamides series, amine oxides series, ethoxylated amines and/or amides, POE stearic acid series, glycerol esters, glycol esters, ethoxylated oxazoline derivatives, monoglycerides and derivatives, lanolin based derivatives, amides, alkanolamides, amine oxides, hydrotropes, lecithin and Lecithin derivatives, phosphorous organic derivatives, sorbitan derivatives, protein based surfactants, allyl polyglycosides, thio and mercapto derivatives, imidazolines and imidazoline derivatives, cetearyl alcohols, emulsifying wax, octyl phenol ethoxylate, sucrose and glucose esters and derivatives, dipropyleneglycol isocetech-20 acetate, phosphate esters, organo-phosphate ester, propylene glycol mono- and diesters of fats ad fatty acids, mono- and diglycerides, partially hydrogenated vegetable oil with lecithin, BHT and citric acid, lauramine oxides, refined soya sterol, emulsified trichlorobenzene, emulsified aromatic and aliphatic solvents and esters, emulsified proprietary aromatic, fatty esters, modified ethoxylate, phenoxy compound, ethylene oxide condensate, polyglyceryl dimerate, lecithin and lecithin derivatives, pentaerythrityl tetracaprylate/tetracaprate, lauramide MEA, linoleamide DEA, coco imidazoline, imidazolines and imidazoline derivatives, carboxylated alcohol or alkylphenol ethoxylates, ethoxylated aryl phenols, and many others. Nonionic surfactants, such as Abex series from Rhodia Inc., Actrafos series from Georgia Pacific, Acconon series from Abitec Corporation, Adsee series from Witco Corp., Aldo series from Lonza Inc., Amidex series from Chemron Corp., Amodox series from Stepan Company, heterocyclic type products, and many other companies. Preferred nonionic surfactants and dispersants include tallow alkyl ethoxylate (such as TAE 80, having 80 molar proportions of ethylene oxide, commercially available from BASF, Ludwigshafen, Germany), Surforic L24-7 from BASF and some others.

Suitable polymeric dispersants include, but are not limited to, polyethylene glycols, PEO polymers, PEO ether, PEO/PPO block polymers, polyether, polyoxyalkylated alcohol, polyoxyethylene styrenated phenyl ether, block copolymer of alkoxylated glycols, polysaccharides, alkyl polyglycosides, PEG, PEG corn glycerides, PEG palm kernel glycerides, polyacrylic acid copolymers, polyacryamides, polymethyl acrylic acid, polyoxyalkylene ether, polyamides, polyproxylated & ethoxylated fatty acids, alcohols, or alkyl phenols, polycarboxylate polymers, any polymers comprising a hydrophilic side chain substituted polyimide or polyamide composition, any polymers having a hydrophilic groups, such as —COOH, a derivative of —COOH, sulfonic acid, a derivative of sulfonic acid, amine, and epoxy. Preferred polymeric surfactants are polyvinyl alcohols (PVOH), Polyvinyl pyrrolidone (PVP), and more.

Suitable silicone-based surfactants are dimethicone copolyols, polysiloxane polyether copolymer, cetyl dimethicone copolyol, polysiloxane polyalkyl polyether copolymers, silicone ethylene oxide copolymers, silicone glycol, cocamide DEA, silicone glycol copolymers, such as Abil® B series, Abil® EM series, Abil® WE series from Goldschmodt AG, Silwet® series from Witco Corporation.

Specific embodiments of the fabric care compositions described herein may further comprise a surfactant quencher. In certain embodiments, the surfactant quencher may be a cationic booster. Without intending to be limited by any theory, it is believed that certain surfactants may inhibit suitable and uniform deposition of at least one of the hydrophobic fluid and/or the particulate material onto the fabric or fiber surface. Therefore, excess or unintended surfactant in the composition or wash/rinse solution may be quenched or otherwise removed using the surfactant quencher. According to certain embodiments, the surfactant quencher may be present in from about 0.001% to about 5.0% by weight of the fabric care composition, or in other embodiments from about 0.05% to about 3.0%. The surfactant quencher according to various embodiments, may have a solubility in the wash solution ranging from about 0.1% to about 40%. In other embodiments, the surfactant quencher may be a cationic surfactant quencher having a cationic charge ranging from about 0.1 milliequivalents/gram (meq/g) to about 23 meq/g. In further embodiments the surfactant quencher may have a molecular weight ranging from about 50 g/mole to about 1000 g/mole. In particular embodiments, the surfactant quencher/cationic booster may be coconut trimethyl ammonium chloride (commercially available from Aldrich Chemical, Milwaukee, Wis.), alkyl dimethyl hydroxymethyl ammonium chloride such as dimethyl hydroxymethyl lauryl ammonium chloride or C₈-C₂₀ alkyl dimethyl hydroxyethyl ammonium chloride (such as that sold under the trade name Praepagen® 3996, commercially available from Clariant Corp, Charlotte, N.C.), dipalmitoyl hydroxyethylammonium methosulfate (such as Stepanquat® 6585, commercially available from Stepan Co., Northfield, Ill.), lauryl trimethyl ammonium chloride (commercially available from Aldrich Chemical, Milwaukee, Wis.), or ditallow dimethyl ammonium chloride (“DTDMAC”, available under the trade name Arquad® 2HT-75 from Fluka Chemical, Milwaukee, Wis.) and/or other cationic surfactants, including blends of the various surfactant quenchers.

Still another embodiment of the present disclosure provides for a fabric care composition comprising an emulsion comprising a polysiloxane-silicone resin mixture comprising a polysiloxane fluid, silicone resin particles, an amphoteric oligomeric/polymeric deposition aid, and water. As described in detail herein, the polysiloxane fluid may comprise: 100 parts by weight of one or more polyorganosiloxanes fluid compounds, as described herein; at least 0.01% by weight of one or more silicone resins, as described herein; and at least 4% by weight of water. The amphoteric oligomeric/polymeric deposition aid may be a cationic polymer selected from the group consisting of a cationic polysaccharide, a cationic guar, a cationic lignin, cationic synthetic polymers and combinations of any thereof. Specific details of the deposition aids are described herein.

In specific embodiments, the amphoteric oligomeric/polymeric deposition aid may be a cationic polysaccharide comprising a branched cationic starch as described herein. For example, in specific embodiments, the branched cationic starch may have at least one of a charge density ranging from about 0.001 meq/g to about 5.0 meq/g of the polymer, and a weight average molecular weight ranging from about 500 Daltons to about 10,000,000 Daltons.

According to specific embodiments, the present disclosure provides for fabric care compositions comprising a) a mixture comprising i) a hydrophobic fluid comprising silicon containing moieties or fluorine containing moieties, wherein the hydrophobic fluid is dispersible in water and ii) a particulate material having a particle size ranging from about 1 nm to about 10,000 nm; b) an amphoteric or cationic oligomeric/polymeric deposition aid; and c) a surfactant quencher. Suitable materials for the hydrophobic fluid, the particulate material, the amphoteric or cationic oligomeric/polymeric deposition aid and the surfactant quencher are described in detail herein.

According to other embodiments, the present disclosure provides for fabric care compositions comprising a) a mixture comprising i) a hydrophobic fluid comprising silicon containing moieties or fluorine containing moieties, wherein the hydrophobic fluid is dispersible in water and ii) a particulate material having a particle size ranging from about 1 nm to about 10,000 nm; b) an amphoteric or cationic oligomeric/polymeric deposition aid; and c) a dispersant aid selected from the group consisting of a non-ionic surfactant, a polymeric surfactant, a silicone-based surfactant and combinations of any thereof. Suitable materials for the hydrophobic fluid, the particulate material, the amphoteric or cationic oligomeric/polymeric deposition aid and the dispersant aid are described in detail herein.

According to other embodiments, the present disclosure provides for fabric care compositions comprising a) a mixture comprising i) a hydrophobic fluid comprising silicon containing moieties or fluorine containing moieties, wherein the hydrophobic fluid is dispersible in water and ii) a particulate material having a particle size ranging from about 1 nm to about 10,000 nm; b) an amphoteric or cationic oligomeric/polymeric deposition aid; c) a surfactant quencher; and a dispersant aid selected from the group consisting of a non-ionic surfactant, a polymeric surfactant, a silicone-based surfactant and combinations of any thereof. Suitable materials for the hydrophobic fluid, the particulate material, the amphoteric or cationic oligomeric/polymeric deposition aid, the surfactant quencher and the dispersant aid are described in detail herein.

The fabric care compositions may also comprise one or more organic solvents, such as, but not limited to, mono- or polyalcohols, for example methanol, ethanol, n-propanol, isopropanol, butanol, n-amylalcohol, i-amylalcohol, diethylene glycol and glycerols; and mono- or polyethers, for example, dioxane, tetrahydrofuran, diethyl ether, diisopropyl ether, propylene glycol, ethylene glycol monobutyl ether, ethylene glycol monohexyl ether, ethylene glycol monomethyl ether, ethylene glycol monoethyl ether, diethylene glycol dimethyl ether, and diethylene glycol diethyl ether. Suitable mono- or polyalcohols and their ethers for solvents according to certain embodiments may have a boiling point or boiling range of a maximum of 260° C. at 0.1 MPa.

The fabric care composition may further comprise one or more additive such as any of the additives discussed herein. In addition, the fabric care composition may be in a form selected from a detergent, a heavy duty liquid detergent, a powder detergent, a laundry rinse additive, a wash additive, a fabric enhancer, a laundry spray, a post-rinse fabric treatment, an ironing aid, a unit dose formulation a dry cleaning composition, a delayed delivery formulation, or combinations of any thereof.

Still other embodiments of the present disclosure provide methods for making a fabric care composition, such as those described herein. Fabrics and textile fibers treated with the fabric care composition will display improved stain repellency compared to the untreated fabrics and textile fiber. According to these embodiments, the methods for making the fabric care compositions comprise adding the emulsion comprising the hydrophobic fluid, particulate material, the amphoteric oligomeric/polymeric deposition aid and water to the fabric care composition. According to these embodiments of the methods, the emulsion comprising the hydrophobic fluid, particulate material and amphoteric oligomeric/polymeric deposition aid may be according to any of the various embodiments described herein. For example, according to one embodiment, the emulsion may comprise a polysiloxane fluid comprising one or more polyorganosiloxanes fluid compounds, one or more silicone resin particulate material, and an amphoteric oligomeric/polymeric deposition aid such as those described in detail herein and water. In one particular embodiment, the amphoteric oligomeric/polymeric deposition aid may comprise a branched, cationic starch, as described herein.

According to specific embodiments, the methods may further comprise adding at least one or more additive or adjuncts to the cleaning composition. Suitable additives or adjuncts include, but are not limited to, bleach activators, surfactants, builders, chelating agents, dye transfer inhibiting agents, dispersants, enzymes, enzyme stabilizers, catalytic metal complexes, polymeric dispersing agents, clay and soil removal/anti-redeposition agents, brighteners, suds suppressors, dyes, perfumes, perfume delivery systems, structure elasticizing agents, fabric softeners, carriers, hydrotropes, solvents, processing aids, and pigments, as described herein. Still other embodiments may comprise adding a surfactant quencher to the emulsion or fabric care composition.

Still further embodiments of the present disclosure provide methods of treating a fabric or textile with the fabric care composition. Other embodiments includes methods for providing improved stain repellency for a textile, compared to a textile that is not treated with the fabric care composition or treated with a conventional fabric care composition. According to these embodiments, the methods may comprise treating a surface or a portion of a surface of a textile with a fabric care composition according to any of the various embodiments described herein. According to various embodiments, the fabric care composition comprises an emulsion comprising a hydrophobic fluid, a particulate material, an amphoteric oligomeric/polymeric deposition aid, and water. According to specific embodiments of the method for providing improved stain repellency for a textile, the particulate material may be capable of forming crosslinks with the hydrophobic fluid and the method may further comprise forming a plurality of crosslinks between the particles and the hydrophobic fluid. Examples of the various types of crosslinking interactions are described in detail herein. Formation of crosslinks may enhance adhesion of the stain repelling composition to the surface of the fabric or textile, provide a more uniform and/or stable coating on the surface of the fabric.

Treating the surface or portion of the surface of the fabric or textile with the fabric care composition may comprise washing, rinsing, spraying soaking, coating, submerging, sprinkling, saturating, or otherwise contacting the fabric or fiber surface with the fabric care composition. Contacting the fabric may be as a pre-laundering treatment or contacting during a cleaning process, such as, during a wash cycle or rinse cycle, or as a post-laundering treatment.

Suitable examples of fabrics that can be treated with the fabric care composition include, but are not limited to, natural fabrics such as cottons, bamboo fabrics, wool fabrics and other fabrics derived from animal fur, silks, linens, and hemp fabrics; and artificial and synthetic fabrics such as polyester fabrics, nylon fabrics, acetate fabrics, rayon fabrics, acrylic fabrics, and olefin fabrics, as well as blends of the various natural fibers, artificial fibers and/or synthetic fibers. According to these embodiments, after treatment, the fabrics will display improved stain repellency compared to untreated fabric.

Certain embodiments of the fabric care compositions may comprise a sufficient amount of a surfactant to provide the desired level of one or more cleaning properties, typically by weight of the total composition, from about 5% to about 90%, from about 5% to about 70% or even from about 5% to about 40% in addition to the emulsions of the present disclosure, to provide a soil and/or stain removal benefit as well as the soil repellency benefits to fabric washed in a solution containing the fabric care composition. Typically according to these embodiments, the fabric care composition is used in the wash solution at a level of from about 0.0001% to about 0.05%, or even from about 0.001% to about 0.01% by weight of the wash solution. As described herein, certain or excess surfactants may necessarily be scavenged or inhibited by a surfactant quencher in certain embodiments of the fabric care composition.

The fabric care compositions may additionally comprise an aqueous, non-surface active liquid carrier. Generally, the amount of the aqueous, non-surface active liquid carrier employed in the compositions herein will be effective to solubilize, suspend or disperse the composition components. For example, the compositions may comprise, by weight, from about 5% to about 90%, from about 10% to about 70%, or even from about 30% to about 80% of an aqueous, non-surface active liquid carrier.

The most cost effective type of aqueous, non-surface active liquid carrier may be water. Accordingly, the aqueous, non-surface active liquid carrier component may be generally mostly, if not completely, water. While other types of water-miscible liquids, such alkanols, diols, other polyols, ethers, amines, and the like, may be conventionally added to cleaning compositions as co-solvents or stabilizers, in certain embodiments of the present disclosure, the utilization of such water-miscible liquids may be minimized to hold down composition cost. Accordingly, in certain embodiments, the aqueous liquid carrier component of the liquid detergent products herein will generally comprise water present in concentrations ranging from about 5% to about 90%, or even from about 30% to about 80%, by weight of the composition.

The fabric care compositions herein, such as, but limited to liquid detergent compositions, may take the form of an aqueous solution or uniform dispersion or suspension of the emulsion comprising the hydrophobic fluid and the particulate material, and certain optional adjunct ingredients, some of which may normally be in solid form, that have been combined with the normally liquid components of the composition, such as the liquid alcohol ethoxylate nonionic, the aqueous liquid carrier, and any other normally liquid optional ingredients. Such a solution, dispersion or suspension will be acceptably phase stable and will typically have a viscosity which ranges from about 50 to 600 cps, more preferably from about 100 to 400 cps. For purposes of this disclosure, viscosity may be measured with a Brookfield LVDV-II+viscometer apparatus using a #21 spindle.

Suitable surfactants that may be used in the fabric care compositions may be anionic, nonionic, cationic, zwitterionic and/or amphoteric surfactants. In one embodiment, the fabric care composition comprises anionic surfactant, nonionic surfactant, a cationic surfactant, or mixtures thereof.

Suitable anionic surfactants may be any of the conventional anionic surfactant types typically used in fabric care compositions, such as liquid or solid detergent products. Such surfactants include the alkyl benzene sulfonic acids and their salts as well as alkoxylated or non-alkoxylated alkyl sulfate materials. Exemplary anionic surfactants are the alkali metal salts of C₁₀-C₁₆ alkyl benzene sulfonic acids, preferably C₁₁-C₁₄ alkyl benzene sulfonic acids. In one aspect, the alkyl group is linear. Such linear alkyl benzene sulfonates are known as “LAS”. Such surfactants and their preparation are described for example in U.S. Pat. Nos. 2,220,099 and 2,477,383. Especially preferred are the sodium and potassium linear straight chain alkylbenzene sulfonates in which the average number of carbon atoms in the alkyl group is from about 11 to 14. Sodium C₁₁-C₁₄, e.g., C₁₂ LAS is a specific example of such surfactants.

Another exemplary type of anionic surfactant comprises ethoxylated alkyl sulfate surfactants. Such materials, also known as alkyl ether sulfates or alkyl polyethoxylate sulfates, are those which correspond to the formula: R′—O—(C₂H₄O)ₙ—SO₃M wherein R′ is a C₈-C₂₀ alkyl group, n is from about 1 to 20, and M is a salt-forming cation. In a specific embodiment, R′ is C₁₀-C₁₈ alkyl, n is from about 1 to 15, and M is sodium, potassium, ammonium, alkylammonium, or alkanolammonium. In more specific embodiments, R′ is a C₁₂-C₁₆, n is from about 1 to 6, and M is sodium.

The alkyl ether sulfates will generally be used in the form of mixtures comprising varying R′ chain lengths and varying degrees of ethoxylation. Frequently such mixtures will inevitably also contain some non-ethoxylated alkyl sulfate materials, i.e., surfactants of the above ethoxylated alkyl sulfate formula wherein n=0. Non-ethoxylated alkyl sulfates may also be added separately to the cleaning compositions of this disclosure and used as or in any anionic surfactant component which may be present. Specific examples of non-alkoxylated, e.g., non-ethoxylated, alkyl ether sulfate surfactants are those produced by the sulfation of higher C₈-C₂₀ fatty alcohols. Conventional primary alkyl sulfate surfactants have the general formula: R″OSO₃⁻M⁺ wherein R″ is typically a linear C₈-C₂₀ hydrocarbyl group, which may be straight chain or branched chain, and M is a water-solubilizing cation. In specific embodiments, R″ is a C₁₀-C₁₅ alkyl, and M is alkali metal, more specifically R″ is C₁₂-C₁₄ and M is sodium.

Specific, non-limiting examples of anionic surfactants useful herein include: a) C₁₁-C₁₈ alkyl benzene sulfonates (LAS); b) C₁₀-C₂₀ primary, branched-chain and random alkyl sulfates (AS); c) C₁₀-C₁₈ secondary (2,3)-alkyl sulfates having Formulae (XII) and (XIII):

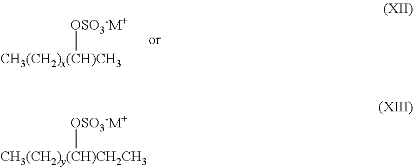

wherein M in Formulae (XII) and (XIII) is hydrogen or a cation which provides charge neutrality, and all M units, whether associated with a surfactant or adjunct ingredient, can either be a hydrogen atom or a cation depending upon the form isolated by the artisan or the relative pH of the system wherein the compound is used, with non-limiting examples of preferred cations including sodium, potassium, ammonium, and mixtures thereof, and x in Formula V is an integer of at least about 7, preferably at least about 9, and y in Formula XIII is an integer of at least 8, preferably at least about 9; d) C₁₀-C₁₈ alkyl alkoxy sulfates (AEₓS) wherein preferably x in Formula XII is from 1-30; e) C₁₀-C₁₈ alkyl alkoxy carboxylates preferably comprising 1-5 ethoxy units; f) mid-chain branched alkyl sulfates as discussed in U.S. Pat. Nos. 6,020,303 and 6,060,443; g) mid-chain branched alkyl alkoxy sulfates as discussed in U.S. Pat. Nos. 6,008,181 and 6,020,303; h) modified alkylbenzene sulfonate (MLAS) as discussed in WO 99/05243, WO 99/05242, WO 99/05244, WO 99/05082, WO 99/05084, WO 99/05241, WO 99/07656, WO 00/23549, and WO 00/23548; i) methyl ester sulfonate (MES); and j) alpha-olefin sulfonate (AOS).

Suitable nonionic surfactants useful herein can comprise any of the conventional nonionic surfactant types typically used in liquid detergent products. These include alkoxylated fatty alcohols and amine oxide surfactants. Preferred for use in the liquid detergent products herein are those nonionic surfactants which are normally liquid. Suitable nonionic surfactants for use herein include the alcohol alkoxylate nonionic surfactants. Alcohol alkoxylates are materials which correspond to the general formula: R¹¹(CₘH₂ₘO)ₙOH wherein R¹¹ is a C₈-C₁₆ alkyl group, m is from 2 to 4, and n ranges from about 2 to 12. Preferably R¹¹ is an alkyl group, which may be primary or secondary, that contains from about 9 to 15 carbon atoms, more preferably from about 10 to 14 carbon atoms. In one embodiment, the alkoxylated fatty alcohols will also be ethoxylated materials that contain from about 2 to 12 ethylene oxide moieties per molecule, more preferably from about 3 to 10 ethylene oxide moieties per molecule.

The alkoxylated fatty alcohol materials useful in the liquid detergent compositions herein will frequently have a hydrophilic-lipophilic balance (HLB) which ranges from about 3 to 17. More preferably, the HLB of this material will range from about 6 to 15, most preferably from about 8 to 15. Alkoxylated fatty alcohol nonionic surfactants have been marketed under the tradename NEODOL® by the Shell Chemical Company.

Another suitable type of nonionic surfactant useful herein comprises the amine oxide surfactants. Amine oxides are materials which are often referred to in the art as “semi-polar” nonionics. Amine oxides have the formula: R′″(EO)ₓ(PO)_{y}(BO)_{z}N(O)(CH₂R′)₂.qH₂O. In this formula, R′″ is a relatively long-chain hydrocarbyl moiety which can be saturated or unsaturated, linear or branched, and can contain from 8 to 20, preferably from 10 to 16 carbon atoms, and is more preferably C₁₂-C₁₆ primary alkyl. R′ is a short-chain moiety, preferably selected from hydrogen, methyl and —CH₂OH. When x+y+z is different from 0, EO is ethyleneoxy, PO is propyleneneoxy and BO is butyleneoxy. Amine oxide surfactants are illustrated by C₁₂-C₁₄ alkyldimethyl amine oxide.

Non-limiting examples of nonionic surfactants include: a) C₁₂-C₁₈ alkyl ethoxylates, such as, NEODOL® nonionic surfactants; b) C₆-C₁₂ alkyl phenol alkoxylates wherein the alkoxylate units are a mixture of ethyleneoxy and propyleneoxy units; c) C₁₂-C₁₈ alcohol and C₆-C₁₂ alkyl phenol condensates with ethylene oxide/propylene oxide block polymers such as PLURONIC® from BASF; d) C₁₄-C₂₂ mid-chain branched alcohols, BA, as discussed in U.S. Pat. No. 6,150,322; e) C₁₄-C₂₂ mid-chain branched alkyl alkoxylates, BAEₓ, wherein x is 1-30, as discussed in U.S. Pat. Nos. 6,153,577; 6,020,303; and 6,093,856; f) alkylpolysaccharides as discussed in U.S. Pat. No. 4,565,647; specifically alkylpolyglycosides as discussed in U.S. Pat. Nos. 4,483,780 and 4,483,779; g) polyhydroxy fatty acid amides as discussed in U.S. Pat. No. 5,332,528; WO 92/06162; WO 93/19146; WO 93/19038; and WO 94/09099; and h) ether capped poly(oxyalkylated) alcohol surfactants as discussed in U.S. Pat. No. 6,482,994 and WO 01/42408.

In various fabric care compositions herein, the detersive surfactant component may comprise combinations of anionic and nonionic surfactant materials. When this is the case, the weight ratio of anionic to nonionic will typically range from 10:90 to 90:10, more typically from 30:70 to 70:30.

Cationic surfactants are well known in the art and non-limiting examples of these include quaternary ammonium surfactants, which can have up to 26 carbon atoms. Additional examples include a) alkoxylate quaternary ammonium (AQA) surfactants as discussed in U.S. Pat. No. 6,136,769; b) dimethyl hydroxyethyl quaternary ammonium as discussed in U.S. Pat. No. 6,004,922; c) polyamine cationic surfactants as discussed in WO 98/35002; WO 98/35003; WO 98/35004; WO 98/35005; and WO 98/35006; d) cationic ester surfactants as discussed in U.S. Pat. Nos. 4,228,042; 4,239,660; 4,260,529; and 6,022,844; and e) amino surfactants as discussed in U.S. Pat. No. 6,221,825 and WO 00/47708, specifically amido propyldimethyl amine (APA).

Non-limiting examples of zwitterionic surfactants include: derivatives of secondary and tertiary amines, derivatives of heterocyclic secondary and tertiary amines, or derivatives of quaternary ammonium, quaternary phosphonium or tertiary sulfonium compounds. See U.S. Pat. No. 3,929,678 at column 19, line 38 through column 22, line 48, for examples of zwitterionic surfactants; betaine, including alkyl dimethyl betaine and cocodimethyl amidopropyl betaine, C₈-C₁₈ (preferably C₁₂-C₁₈) amine oxides and sulfo and hydroxy betaines, such as N-alkyl-N,N-dimethylammino-1-propane sulfonate where the alkyl group can be C₈-C₁₈, preferably C₁₀-C₁₄.

Non-limiting examples of ampholytic surfactants include: aliphatic derivatives of secondary or tertiary amines, or aliphatic derivatives of heterocyclic secondary and tertiary amines in which the aliphatic radical can be straight- or branched-chain. One of the aliphatic substituents contains at least about 8 carbon atoms, typically from about 8 to about 18 carbon atoms, and at least one contains an anionic water-solubilizing group, e.g. carboxy, sulfonate, sulfate. See U.S. Pat. No. 3,929,678 at column 19, lines 18-35, for examples of ampholytic surfactants.

In another aspect of the present disclosure, the fabric care compositions disclosed herein, may take the form of granular laundry detergent compositions. Such compositions comprise the dispersant polymer of the present disclosure to provide soil and stain removal and anti-redeposition, suds boosting, and/or soil release benefits to fabric washed in a solution containing the detergent. Typically, the granular laundry detergent compositions are used in washing solutions at a level of from about 0.0001% to about 0.05%, or even from about 0.001% to about 0.01% by weight of the washing solution.

Granular detergent compositions of the present disclosure may include any number of conventional detergent ingredients. For example, the surfactant system of the detergent composition may include anionic, nonionic, zwitterionic, ampholytic and cationic classes and compatible mixtures thereof. Detergent surfactants for granular compositions are described in U.S. Pat. Nos. 3,664,961 and 3,919,678. Cationic surfactants include those described in U.S. Pat. Nos. 4,222,905 and 4,239,659.

If desired, the conventional nonionic and amphoteric surfactants such as the C₁₂-C₁₈ alkyl ethoxylates (“AE”) including the so-called narrow peaked alkyl ethoxylates and C₆-C₁₂ alkyl phenol alkoxylates (especially ethoxylates and mixed ethoxy/propoxy), C₁₂-C₁₈ betaines and sulfobetaines (“sultaines”), C₁₀-C₁₈ amine oxides, and the like, can also be included in the surfactant system. The C₁₀-C₁₈ N-alkyl polyhydroxy fatty acid amides can also be used. See WO 92/06154. Other sugar-derived surfactants include the N-alkoxy polyhydroxy fatty acid amides, such as C₁₀-C₁₈ N-(3-methoxypropyl) glucamide. The N-propyl through N-hexyl C₁₂-C₁₈ glucamides can be used for low sudsing. C₁₀-C₂₀ conventional soaps may also be used. If high sudsing is desired, the branched-chain C₁₀-C₁₆ soaps may be used. Mixtures of anionic and nonionic surfactants are especially useful. Other conventional useful surfactants are listed in standard texts.

The fabric care composition can, and in certain embodiments preferably does, include a detergent builder. Builders are generally selected from the various water-soluble, alkali metal, ammonium or substituted ammonium phosphates, polyphosphates, phosphonates, polyphosphonates, carbonates, silicates, borates, polyhydroxy sulfonates, polyacetates, carboxylates, and polycarboxylates. Preferred are the alkali metals, especially sodium, salts of the above. Preferred for use herein are the phosphates, carbonates, silicates, C₁₀-C₁₈ fatty acids, polycarboxylates, and mixtures thereof. More preferred are sodium tripolyphosphate, tetrasodium pyrophosphate, citrate, tartrate mono- and di-succinates, sodium silicate, and mixtures thereof.

Specific examples of inorganic phosphate builders are sodium and potassium tripolyphosphate, pyrophosphate, polymeric metaphosphate having a degree of polymerization of from about 6 to 21, and orthophosphates. Examples of polyphosphonate builders are the sodium and potassium salts of ethylene diphosphonic acid, the sodium and potassium salts of ethane 1-hydroxy-1,1-diphosphonic acid and the sodium and potassium salts of ethane-1,1,2-triphosphonic acid. Other phosphorus builder compounds are disclosed in U.S. Pat. Nos. 3,159,581; 3,213,030; 3,422,021; 3,422,137; 3,400,176; and 3,400,148. Examples of non-phosphorus, inorganic builders are sodium and potassium carbonate, bicarbonate, sesquicarbonate, tetraborate decahydrate, and silicates having a weight ratio of SiO₂ to alkali metal oxide of from about 0.5 to about 4.0, preferably from about 1.0 to about 2.4. Water-soluble, non-phosphorus organic builders useful herein include the various alkali metal, ammonium and substituted ammonium polyacetates, carboxylates, polycarboxylates and polyhydroxy sulfonates. Examples of polyacetate and polycarboxylate builders are the sodium, potassium, lithium, ammonium and substituted ammonium salts of ethylene diamine tetraacetic acid, nitrilotriacetic acid, oxydisuccinic acid, mellitic acid, benzene polycarboxylic acids, and citric acid.

Polymeric polycarboxylate builders are set forth in U.S. Pat. No. 3,308,067. Such materials include the water-soluble salts of homo- and copolymers of aliphatic carboxylic acids such as maleic acid, itaconic acid, mesaconic acid, fumaric acid, aconitic acid, citraconic acid and methylenemalonic acid. Some of these materials are useful as the water-soluble anionic polymer as hereinafter described, but only if in intimate admixture with the non-soap anionic surfactant. Other suitable polycarboxylates for use herein are the polyacetal carboxylates described in U.S. Pat. Nos. 4,144,226 and 4,246,495.

Water-soluble silicate solids represented by the formula SiO₂-M₂O, M being an alkali metal, and having a SiO₂:M₂O weight ratio of from about 0.5 to about 4.0, are useful salts in the detergent granules of this disclosure at levels of from about 2% to about 15% on an anhydrous weight basis. Anhydrous or hydrated particulate silicate can be utilized, as well.

Any number of additional ingredients can also be included as components in the various fabric care described herein. These include other detergency builders, bleaches, bleach activators, suds boosters or suds suppressors, anti-tarnish and anti-corrosion agents, soil suspending agents, soil release agents, germicides, pH adjusting agents, non-builder alkalinity sources, chelating agents, smectite clays, enzymes, enzyme-stabilizing agents and perfumes. See, for example, U.S. Pat. No. 3,936,537.

Bleaching agents and activators are described in U.S. Pat. Nos. 4,412,934 and 4,483,781. Chelating agents are also described in U.S. Pat. No. 4,663,071 from column 17, line 54 through column 18, line 68. Suds modifiers are also optional ingredients and are described in U.S. Pat. Nos. 3,933,672 and 4,136,045. Suitable smectite clays for use herein are described in U.S. Pat. No. 4,762,645 column 6, line 3 through column 7, line 24. Suitable additional detergency builders for use herein are enumerated in U.S. Pat. No. 3,936,537 at column 13, line 54 through column 16, line 16, and in U.S. Pat. No. 4,663,071.

In yet another aspect of the present disclosure, the fabric care compositions disclosed herein may take the form of rinse added fabric conditioning compositions. Such compositions may comprise a fabric softening active and the dispersant polymer of the present disclosure, to provide a stain repellency benefit to fabrics treated by the composition, typically from about 0.00001 wt. % (0.1 ppm) to about 1 wt. % (10,000 ppm), or even from about 0.0003 wt. % (3 ppm) to about 0.03 wt. % (300 ppm) based on total rinse added fabric conditioning composition weight. In another specific embodiment, the compositions are rinse added fabric conditioning compositions. Examples of typical rinse added conditioning composition can be found in U.S. Provisional Patent Application Ser. No. 60/687,582 filed on Oct. 8, 2004.

### Adjunct Materials

While not essential for the purposes of the present disclosure, the non-limiting list of additives or adjuncts illustrated hereinafter are suitable for use in various embodiments of the fabric care compositions and may be desirably incorporated in certain embodiments of the disclosure, for example to assist or enhance performance or to modify the aesthetics of the composition as is the case with perfumes, colorants, dyes or the like. In the present disclosure, the terms “additive” and adjunct” may be used interchangeably. It is understood that such adjuncts are in addition to the components that were previously listed for any particular embodiment. The total amount of such adjuncts may range from about 0.1% to about 50%, or even from about 1% to about 30%, by weight of the fabric care composition.

The precise nature of these additional components, and levels of incorporation thereof, will depend on the physical form of the fabric care composition and the nature of the operation for which it is to be used. Suitable additive and adjunct materials include, but are not limited to, polymers, for example cationic polymers, surfactants, builders, chelating agents, dye transfer inhibiting agents, dispersants, enzymes, and enzyme stabilizers, catalytic materials, bleach activators, polymeric dispersing agents, clay soil removal/anti-redeposition agents, brighteners, suds suppressors, dyes, additional perfume and perfume delivery systems, structure elasticizing agents, fabric softeners, carriers, hydrotropes, processing aids and/or pigments. In addition to the disclosure below, suitable examples of such other adjuncts and levels of use are found in U.S. Pat. Nos. 5,576,282; 6,306,812; and 6,326,348.

As stated, the adjunct ingredients are not essential to the fabric care compositions. Thus, certain embodiments of the compositions do not contain one or more of the following adjuncts materials: bleach activators, surfactants, builders, chelating agents, dye transfer inhibiting agents, dispersants, enzymes, and enzyme stabilizers, catalytic metal complexes, polymeric dispersing agents, clay and soil removal/anti-redeposition agents, brighteners, suds suppressors, dyes, additional perfumes and perfume delivery systems, structure elasticizing agents, fabric softeners, carriers, hydrotropes, processing aids and/or pigments. However, when one or more adjuncts are present, such one or more adjuncts may be present as detailed below:

Surfactants—The compositions according to the present disclosure can comprise a surfactant or surfactant system wherein the surfactant can be selected from nonionic and/or anionic and/or cationic surfactants and/or ampholytic and/or zwitterionic and/or semi-polar nonionic surfactants. The surfactant is typically present at a level of from about 0.1%, from about 1%, or even from about 5% by weight of the cleaning compositions to about 99.9%, to about 80%, to about 35%, or even to about 30% by weight of the cleaning compositions.

Builders—The compositions of the present disclosure can comprise one or more detergent builders or builder systems. When present, the compositions will typically comprise at least about 1% builder, or from about 5% or 10% to about 80%, 50%, or even 30% by weight, of said builder. Builders include, but are not limited to, the alkali metal, ammonium and alkanolammonium salts of polyphosphates, alkali metal silicates, alkaline earth and alkali metal carbonates, aluminosilicate builders polycarboxylate compounds, ether hydroxypolycarboxylates, copolymers of maleic anhydride with ethylene or vinyl methyl ether, 1,3,5-trihydroxybenzene-2,4,6-trisulphonic acid, and carboxymethyl-oxysuccinic acid, the various alkali metal, ammonium and substituted ammonium salts of polyacetic acids such as ethylenediamine tetraacetic acid and nitrilotriacetic acid, as well as polycarboxylates such as mellitic acid, succinic acid, oxydisuccinic acid, polymaleic acid, benzene 1,3,5-tricarboxylic acid, carboxymethyloxysuccinic acid, and soluble salts thereof.

Chelating Agents—The compositions herein may also optionally contain one or more copper, iron and/or manganese chelating agents. If utilized, chelating agents will generally comprise from about 0.1% by weight of the compositions herein to about 15%, or even from about 3.0% to about 15% by weight of the compositions herein.

Dye Transfer Inhibiting Agents—The compositions of the present disclosure may also include one or more dye transfer inhibiting agents. Suitable polymeric dye transfer inhibiting agents include, but are not limited to, polyvinylpyrrolidone polymers, polyamine N-oxide polymers, copolymers of N-vinylpyrrolidone and N-vinylimidazole (PVPVI), polyvinyloxazolidones and polyvinylimidazoles or mixtures thereof. When present in the compositions herein, the dye transfer inhibiting agents are present at levels from about 0.0001%, from about 0.01%, from about 0.05% by weight of the cleaning compositions to about 10%, about 2%, or even about 1% by weight of the cleaning compositions.

Dispersants—The compositions of the present disclosure can also contain dispersants. Suitable water-soluble organic materials are the homo- or co-polymeric acids or their salts, in which the polycarboxylic acid may comprise at least two carboxyl radicals separated from each other by not more than two carbon atoms.

Enzymes—The compositions can comprise one or more detergent enzymes which provide cleaning performance and/or fabric care benefits. Examples of suitable enzymes include, but are not limited to, hemicellulases, peroxidases, proteases, cellulases, xylanases, lipases, phospholipases, esterases, cutinases, pectinases, keratanases, reductases, oxidases, phenoloxidases, lipoxygenases, ligninases, pullulanases, tannases, pentosanases, malanases, 13-glucanases, arabinosidases, hyaluronidase, chondroitinase, laccase, and amylases, or mixtures thereof. A typical combination is a cocktail of conventional applicable enzymes like protease, lipase, cutinase and/or cellulase in conjunction with amylase.

Enzyme Stabilizers—Enzymes for use in compositions, for example, detergents can be stabilized by various techniques. The enzymes employed herein can be stabilized by the presence of water-soluble sources of calcium and/or magnesium ions in the finished compositions that provide such ions to the enzymes.

Catalytic Metal Complexes—The compositions may include catalytic metal complexes. One type of metal-containing bleach catalyst is a catalyst system comprising a transition metal cation of defined bleach catalytic activity, such as copper, iron, titanium, ruthenium, tungsten, molybdenum, or manganese cations, an auxiliary metal cation having little or no bleach catalytic activity, such as zinc or aluminum cations, and a sequestrate having defined stability constants for the catalytic and auxiliary metal cations, particularly ethylenediaminetetraacetic acid, ethylenediaminetetra(methylenephosphonic acid) and water-soluble salts thereof. Such catalysts are disclosed in U.S. Pat. No. 4,430,243.

If desired, the compositions herein can be catalyzed by means of a manganese compound. Such compounds and levels of use are well known in the art and include, for example, the manganese-based catalysts disclosed in U.S. Pat. No. 5,576,282.

Cobalt bleach catalysts useful herein are known, and are described, for example, in U.S. Pat. Nos. 5,597,936 and 5,595,967. Such cobalt catalysts are readily prepared by known procedures, such as taught for example in U.S. Pat. Nos. 5,597,936, and 5,595,967.

Compositions herein may also suitably include a transition metal complex of a macropolycyclic rigid ligand (“MRL”). As a practical matter, and not by way of limitation, the compositions and cleaning processes herein can be adjusted to provide on the order of at least one part per hundred million of the benefit agent MRL species in the aqueous washing medium, and may provide from about 0.005 ppm to about 25 ppm, from about 0.05 ppm to about 10 ppm, or even from about 0.1 ppm to about 5 ppm, of the MRL in the wash liquor.

Preferred transition-metals in the instant transition-metal bleach catalyst include manganese, iron and chromium. Preferred MRLs herein are a special type of ultra-rigid ligand that is cross-bridged such as 5,12-diethyl-1,5,8,12-tetraazabicyclo[6.6.2]hexadecane. Suitable transition metal MRLs are readily prepared by known procedures, such as taught, for example, in WO 00/32601, and U.S. Pat. No. 6,225,464.

### Processes of Making Fabric Care Compositions

The fabric care compositions of the present disclosure can be formulated into any suitable form and prepared by any process chosen by the formulator, non-limiting examples of which are described in U.S. Pat. Nos. 5,879,584; 5,691,297; 5,574,005; 5,569,645; 5,565,422; 5,516,448; 5,489,392; and 5,486,303.

In one aspect, the fabric care compositions disclosed herein may be prepared by combining the components thereof in any convenient order and by mixing, e.g., agitating, the resulting component combination to form a phase stable fabric care composition. In one aspect, a liquid matrix is formed containing at least a major proportion, or even substantially all, of the liquid components and the emulsion, e.g., nonionic surfactant, the non-surface active liquid carriers and other optional liquid components, with the liquid components being thoroughly admixed by imparting shear agitation to this liquid combination. For example, rapid stifling with a mechanical stirrer may usefully be employed. While shear agitation is maintained, substantially all of any anionic surfactant and the solid ingredients can be added. Agitation of the mixture is continued, and if necessary, can be increased at this point to form a solution or a uniform dispersion of insoluble solid phase particulates within the liquid phase. After some or all of the solid-form materials have been added to this agitated mixture, particles of any enzyme material to be included, e.g., enzyme prills are incorporated. As a variation of the composition preparation procedure described above, one or more of the solid components may be added to the agitated mixture as a solution or slurry of particles premixed with a minor portion of one or more of the liquid components. After addition of all of the composition components, agitation of the mixture is continued for a period of time sufficient to form compositions having the requisite viscosity and phase stability characteristics. Frequently this will involve agitation for a period of from about 30 to 60 minutes.

In another aspect of producing liquid fabric care compositions, the emulsion comprising the hydrophobic fluid and particulate material may first be combined with one or more liquid components to form a premix, and this premix may be added to a composition formulation containing a substantial portion, for example more than 50% by weight, more than 70% by weight, or even more than 90% by weight, of the balance of components of the fabric care composition. For example, in the methodology described above, both the premix and the enzyme component may be added at a final stage of component additions.

Various techniques for forming fabric care compositions in such solid forms are well known in the art and may be used herein. In one aspect, when the fabric care composition is in the form of a granular particle, the emulsion is provided in particulate or encapsulated form, optionally including additional but not all components of the cleaning composition. The particulate comprising the emulsion material is combined with one or more additional particulates containing a balance of components of the cleaning composition. In various embodiments, the emulsion comprising the polyorganosiloxane having aminoalkyl groups and the silicone particulate material, optionally including additional but not all components of the cleaning composition may be provided in an encapsulated form, and the emulsion encapsulate is combined with particulates containing a substantial balance of components of the fabric care composition.

### Methods of Using Fabric Care Compositions

The fabric care compositions disclosed in the present specification may be used to clean or treat a fabric, such as those described herein. Typically at least a portion of the fabric is contacted with an embodiment of the aforementioned fabric care compositions, in neat form or diluted in a liquor, for example, a wash liquor and then the fabric may be optionally washed and/or rinsed. In one aspect, a fabric is optionally washed and/or rinsed, contacted with an embodiment of the aforementioned fabric care compositions and then optionally washed and/or rinsed. For purposes of the present disclosure, washing includes but is not limited to, scrubbing, and mechanical agitation. The fabric may comprise most any fabric capable of being laundered or treated.

In certain embodiments, the fabric care compositions disclosed in the present specification can be used to form aqueous washing solutions for use in the laundering of fabrics. Generally, an effective amount of such compositions is added to water, preferably in a conventional fabric laundering automatic washing machine, to form such aqueous laundering solutions. The aqueous washing solution so formed is then contacted, preferably under agitation, with the fabrics to be laundered therewith. An effective amount of the fabric care composition, such as the liquid detergent compositions disclosed in the present specification, may be added to water to form aqueous laundering solutions that may comprise from about 500 to about 7,000 ppm or even from about 1,000 to about 3,000 pm of fabric care composition. The compositions according to the present disclosure may be used in various types of washing machines and processes, including, but not limited to, top loading washing machines, front loading washing machines, Miele type washing machines, commercial washing machines, industrial washing machines, and hand washing processes.

In one aspect, the fabric care compositions may be employed as a laundry additive, a pre-treatment composition and/or a post-treatment composition. For example, in certain embodiments, the fabric care composition may be in the form of a spray which is sprayed on a surface of the fabric. In other embodiments, the fabric care composition treatment may be in the form of a soak or rinse composition, such as a pre- or post-laundering soak or rinse composition. In these embodiments, the fabric to be treated may be soaked or rinsed in the fabric care composition to impart the enhanced stain repellency characteristics.

While various specific embodiments have been described in detail herein, the present disclosure is intended to cover various different combinations of the disclosed embodiments and is not limited to those specific embodiments described herein. The various embodiments of the present disclosure may be better understood when read in conjunction with the following representative examples. The following representative examples are included for purposes of illustration and not limitation.

### EXAMPLES

### 1) Emulsion Preparation-Emulsion Mixtures

### 1.1. Preparation of a Stable Oil Mixture

13.2 g of MQ silicone resin ({[Me₃SiO_{1/2}]_{0.373}[SiO₂]_{0.627}}₄₀, Mn=2700 g/mol, resin contains appr. 0.2% OH and 3.1% OEt [corresponds to R¹⁰]) are dissolved in 10.5 g of ethylene glycol monohexyl ether (obtainable from Sigma-Aldrich Chemie GmbH) by stifling and subsequently admixed with 76.3 g of amine oil (viscosity about 1000 mm²/s at 25° C. [corresponds to Ia+Ib+II+III=230], functional radicals —(CH₂)₃NH(CH₂)NH₂ [corresponds to R²], amine number of 0.6 mmol/g, 90 mol % SiMe₃ end groups, 10 mol % SiMe₂OH end groups [corresponds to II/III=9.0]) at 25° C. to obtain a clear, colorless solution having a viscosity of about 3000 mPa·s. This mixture is stable for a period of 3 months.

### 1.2. Preparation of a Stable Oil Mixture

13.2 g of MQ silicone resin ({[Me₃SiO_{1/2}]_{0.373}[SiO₂]_{0.627}}₄₀, Mn=2700 g/mol, resin contains appr. 0.2% OH and 3.1% OEt [corresponds to R¹⁰]) are dissolved in 10.5 g of ethylene glycol monohexyl ether (obtainable from Sigma-Aldrich Chemie GmbH) by stifling and subsequently admixed with 76.3 g of amine oil (viscosity about 500 mm²/s at 25° C. [corresponds to Ia+Ib+II+III=170], functional radicals —(CH₂)₃NH(CH₂)NH₂ [corresponds to R²], amine number of 0.6 mmol/g, 68 mol % SiMe₃ end groups, 25 mol % SiMe₂OH end groups, 7 mol % SiMe₂OMe end groups [corresponds to II/III=2.1]) at 25° C. to obtain a clear, colorless solution having a viscosity of about 3000 mPa·s. This mixture is stable for a period of 3 months.

### 1.3. Preparation of a Stable Oil Mixture

13.2 g of MQ silicone resin ({[Me₃SiO_{1/2}]_{0.373}[SiO₂]_{0.627}}₄₀, Mn=2700 g/mol, resin contains appr. 0.2% OH and 3.1% OEt [corresponds to R¹⁰]) are dissolved in 10.5 g of ethylene glycol monohexyl ether (obtainable from Sigma-Aldrich Chemie GmbH) by stifling and subsequently admixed with 76.3 g of amine oil (viscosity about 950 mm²/s at 25° C. [corresponds to Ia+Ib+II+III=220], functional radicals —(CH₂)₃NH(CH₂)NH₂ [corresponds to R²], amine number of 0.6 mmol/g, 92 mol % SiMe₃ end groups, 7 mol % SiMe₂OH end groups, 1 mol % SiMe₂OMe end groups [corresponds to II/III=11.5]) at 25° C. to obtain a clear, colorless solution having a viscosity of about 3000 mPa·s. This mixture is stable for a period of 3 months.

### 1.4. Preparation of a Stable Oil Mixture

13.2 g of MQ silicone resin ({[Me₃SiO_{1/2}]_{0.373}[SiO₂]_{0.627}}₄₀, Mn=2700 g/mol, resin contains appr. 0.2% OH and 3.1% OEt [corresponds to R¹⁰]) are dissolved in 10.5 g of ethylene glycol monohexyl ether (obtainable from Sigma-Aldrich Chemie GmbH) by stifling and subsequently admixed with 76.3 g of amine oil (viscosity about 2500 mm²/s at 25° C. [corresponds to Ia+Ib+II+III=315], functional radicals —(CH₂)₃NH(CH₂)NH₂ [corresponds to R²], amine number of 0.8 mmol/g, 72 mol % SiMe₃ end groups, 26 mol % SiMe₂OH end groups, 2 mol % SiMe₂OMe end groups [corresponds to II/III=2.6]) at 25° C. to obtain a clear, colorless solution having a viscosity of about 3000 mPa·s. This mixture is stable for a period of 3 months.

### 1.5. Preparation of a Stable Oil Mixture

3.5 g of MQ silicone resin ({[Me₃SiO_{1/2}]_{0.373}[SiO₂]_{0.627}}₄₀, Mn=2700 g/mol, resin contains appr. 0.2% OH and 3.1% OEt [corresponds to R¹⁰]) are mixed for 30 minutes with 20.2 g of amine oil (viscosity about 225 mm²/s at 25° C. [corresponds to Ia+Ib+II+III=105], functional radicals —(CH₂)₃NH(CH₂)NH₂ [corresponds to R²], amine number of 2.6 mmol/g, 94 mol % SiMe₃ end groups, 5 mol % SiMe₂OH end groups, 1 mol % SiMe₂OMe end groups [corresponds to II/III=15.7]).

### 1.6. Preparation of a Stable Oil Mixture

5.9 g of DT silicone resin solution ({[Me₂SiO]_{0.03}[MeSiO_{3/2}]_{0.97}}₃₃, Mn=2300 g/mol, resin contains appr. 0.4% OH and 4.4% OEt [corresponds to R¹⁰], 25% in Shellsol T) are disolved in 3.6 g ethylene glycol monohexyl ether (obtainable from Sigma-Aldrich Chemie GmbH) by stirring and subsequently admixed with 14.2 g of amine oil (viscosity about 1000 mm²/s at 25° C. [corresponds to Ia+Ib+II+III=230], functional radicals —(CH₂)₃NH(CH₂)NH₂ [corresponds to R²], amine number of 0.6 mmol/g, 90 mol % SiMe₃ end groups, 10 mol % SiMe₂OH end groups [corresponds to II/III=9.0]) at 25° C. to obtain a clear, colorless solution having a viscosity of about 3000 mPa·s. This mixture is stable for a period of 3 months.

### 1.7. Preparation of an Unstable Oil Mixture

13.2 g of MQ silicone resin ({[Me₃SiOi_{1/2}]_{0.373}[SiO₂]_{0.627}}₄₀, Mn=2700 g/mol, resin contains appr. 0.2% OH and 3.1% OEt [corresponds to R¹⁰]) are dissolved in 10.5 g of ethylene glycol monohexyl ether (obtainable from Sigma-Aldrich Chemie GmbH) by stifling and subsequently admixed with 76.3 g of amine oil (viscosity about 2800 mm²/s at 25° C. [corresponds to Ia+Ib+II+III=325], functional radicals —(CH₂)₃NH(CH₂)NH₂ [corresponds to R²], amine number of 0.6 mmol/g, 47 mol % SiMe₃ end groups, 45 mol % SiMe₂OH end groups, 8 mol % SiMe₂OMe end groups [corresponds to II/III=0.9]) at 25° C. to obtain a clear, colorless solution having a viscosity of about 3000 mPa·s. This mixture has formed a gel after 3 days; the preparation of an emulsion is only possible within these three days.

### 1.8. Preparation of an Unstable Oil Mixture

13.2 g of MQ silicone resin ({[Me₃SiO_{1/2}]_{0.373}[SiO₂]_{0.627}}₄₀, Mn=2700 g/mol, resin contains appr. 0.2% OH and 3.1% OEt [corresponds to R¹⁰]) are dissolved in 10.5 g of ethylene glycol monohexyl ether (obtainable from Sigma-Aldrich Chemie GmbH) by stifling and subsequently admixed with 76.3 g of amine oil (viscosity about 2900 mm²/s at 25° C. [corresponds to Ia+Ib+II+III=331], functional radicals —(CH₂)₃NH(CH₂)NH₂ [corresponds to R²], amine number of 0.4 mmol/g, 47 mol % SiMe₃ end groups, 47 mol % SiMe₂OH end groups, 6 mol % SiMe₂OMe end groups [corresponds to II/III=0.9]) at 25° C. to obtain a clear, colourless solution having a viscosity of about 3000 mPa·s. This mixture has formed a gel after 3 days; the preparation of an emulsion is only possible within these three days.

### Preparation of Emulsions

General Prescription for the Emulsification of the Oil Mixtures 1.1 to 1.8: (the Emulsions of Mixers 1.1 Through 1.8 are Herein after Called Emulsion 1-8.)

8.0 g of demineralized water, 12.0 g of diethylene glycol monobutyl ether (obtainable from Sigma-Aldrich Chemie GmbH), 1.5 g of diethylene glycol monohexyl ether (obtainable from Sigma-Aldrich Chemie GmbH) and acetic acid 100% (equimolar to the amine groups of the aminoalkyl-containing polyorganosiloxanes, obtainable from VWR International) are initially charged and mixed at room temperature, then 39.0 g of the above-described oil mixture are added at room temperature and subsequently a further 46.5 g of demineralized water are added with stirring to obtain an almost clear, colorless emulsion. Oil mixtures 5 and 6 were emulsified immediately after their preparation.

### General Prescription for the Emulsification of the Oil Mixtures 1.1 and 1.2 in Presence of Polyvinyl Alcohol (Emulsion 9-10):

17 g polyvinyl alcohol “Celvol 523” (obtainable from Sekisui Specialty Chemicals America), 10% in water (obtainable from Wacker Chemie AG), 23 g polyvinyl alcohol M05/140 M, 20% in water (obtainable from Wacker Chemie AG) and 4.0 g diethylenglykol monohexylether (obtainable from Sigma-Aldrich Chemie GmbH) are initially charged and mixed at room temperature, then 39.0 g of the above-described oil mixture are added at room temperature and subsequently 29.0 g of demineralized water are added with stirring to obtain an opaque, colorless emulsion.

### 2) Deposition Aid Solution Formulation

Deposition aid materials were pre-dissolved in aqueous phase. Heating was used if necessary. The concentration of the deposition aid varies depends on the solubility of the materials.

### 3) Exemplary Formulation of Emulsion Composition

To 39.35 g deionized water was added 18.40 g stable oil mixture (b) and the mixture agitated with an IKA® RK20 bench-top mixer set to 300 rpm until solution became clear. Arquad® HTL8-MS (0.78 g) was added and the mixture agitated with the IKA® RK20 at 300 rpm until combined and solution became clear. The solution was heated to 50° C. by placing sample in an oven set to 50° C. until temperature of sample equilibrated. Deposition aid (1.20 g, Dow Polymer PK™) was added and the mixture agitated with the IKA® RK20 at 200 rpm. The deposition aid powder was added slowly in small, equal batches to allow even dispersion. Deposition aid forms gel in the aqueous solution and thickens the solution. The agitation speed was increased to 300 rpm. Perfume and dye were added and the mixture agitated at 300 rpm for 15 minutes to provide the stabile emulsion.

### 4) Fabric Treatment Method:

A fixed quantity of fresh fabrics, such as CW120, polyester, blend polycotton, socks, T-shirts and other type of fabrics was washed at normal wash conditions using Tide 2× at 32° C. at North American top load washing machine and wash conditions. The above formulated product was added into the washing machine before the rinse cycle and after the wash cycle. Then the normal laundry process was continued. After rinse, all the fabrics were taken out to dryer. The fabrics went through the normal drying process at 49° C. After leaving in the room temperature for 1 day, the fabrics was test for Time to Wick using the test method shown below.

Three control formulations and 10 formulations according to various embodiments of the present disclosure were prepared and tested for time-to-wick. The control formulations included untreated fabric (control 1), formulations comprising the stable oil mixture of 1.1 (control 3) or the stable oil mixture of 1.2 (control 2). Examples for the controls and formulations 1-7 were performed using the equivalent of a 60 g per load dose (on a full scale top load) and miniwash scale (i.e., at ⅛th scale) followed by the time-to-wick tests. Formulations 8-10 were used in a 30 g per load dose (on a full scale top load) and a full scale wash followed by the time-to-wick test. The results for controls and inventive formulations are presented in Table 1.

### 5). Liquid Laundry Additive Compositions

The above emulsions were then made into products with the following formulation. The formulated products were used in the rinse cycle in the washing machine with loaded cotton garments. Normal wash conditions were used and Tide detergent was used in the wash cycle.

Formula (w/w active %)

| | |
|---|---|
| Si Fluid-Resin Emulsion of Example 1-10 | 10.67 |
| Cationic Starch (Maize, MW 1,500,000 | 0.72 |
| Daltons, charge density 0.42 meq/g, amylase | |
| 28%) | |
| DTDMAC | 1.33 |
| Perfume: | 0.20 |
| Preservant: Proxel | 0.015 |

Cotton fabric was dipped in the solution and then line dried. The time to wick was measured on the fabrics according to the T2W testing method.

| | Water T2W |
|---|---|
| Untreated | 0 second |
| Product/Example 5.1-Emulsion 1 | 977 second |
| Product/Example 5.2-Emulsion 2 | 1200 second |
| Product/Example 5.3-Emulsion 3 | 1200 second |
| Product/Example 5.4-Emulsion 4 | 12 second |
| Product/Example 5.5-Emulsion 5 | 287 second |
| Product/Example 5.6-Emulsion 6 | 191 second |
| Product/Example 5.7-Emulsion 7* | Not applicable |
| | (unstable) |
| Product/Example 5.8-Emulsion 8* | Not applicable |
| | (unstable) |
| Product/Example 5.9-Emulsion 9 | 680 second |
| Product/Example 5.10-Emulsion 10 | 887 second |

Formula (w/w active %)

| | |
|---|---|
| Si Fluid-Resin Emulsion 1 | 12 |
| Cationic Starch (Maize, MW 1,500,000 | 1.2 |
| Daltons, charge density 0.42 meq/g, amylase 28%) | |
| Tallow alkyl ethoxylate (TAE 80, approx. 80 molar | 0.1 |
| proportions of ethylene oxide) | |
| Diethylene glycol mono-butyl ether | 1.0 |
| ethylene glycol mono hexyl ether | 1.0 |
| Perfume: | 0.20 |
| Preservant: Proxel | 0.02 |

| | Water T2W |
|---|---|
| Untreated | 0 second |
| Product/Example 5.11-Emulsion 1 | 45 second |

Additional example formulations of the compositions of the present invention are shown in Table 1.

### Additional Example Formulations

Examples of Control 1 to Formulation 7 are based on a dosage of 60 g of formulation per load with washing in a miniwasher.

Examples of Formulation 8-10 are all based on a dosage of 30 g of formulation per load with washing in a full scale washing machine

Longer Time to Wick (T2W) times show increased benefit.

TABLE 1
Formula (w/w % ACTIVE PER DOSE)

| | | Control 1 | | | | | | |
|---|---|---|---|---|---|---|---|---|
| | | (untreated | Control | Control | Formulation | Form. | Form. | Form. |
| Class | Material | fabrics) | 2 | 3 | 1 | 2 | 3 | 4 |
| Emulsion | Emulsified Polyorganosiloxane | — | 10.7 | — | 10.7 | 10.7 | 10.7 | 10.7 |
| Mixture | fluid-silicone resin mixture from | | | | | | | |
| | above Example 1.2 (Emulsion 2) | | | | | | | |
| Emulsion | Emulsified Polyorganosiloxane | — | — | 10.7 | — | — | — | — |
| Mixture | fluid-silicone resin mixture from | | | | | | | |
| | above example 1.1 (Emulsion 1) | | | | | | | |
| Deposition | Cationic Hydroxyl Ethyl Cellulose | — | — | — | 1.8 | — | 1.8 | 1.8 |
| Aid | (MW 400,000 Daltons, charge | | | | | | | |
| | density 1.25 meq/g) (Dow, Cat | | | | | | | |
| | HEC polymer PK) | | | | | | | |
| Deposition | Cationic Starch (Maize, MW | — | — | — | — | — | — | — |
| Aid | 1,500,000 Daltons, charge density | | | | | | | |
| | 0.42 meq/g, amylase 28%) (Akzo, | | | | | | | |
| | EXP 5617-2301-28) (National | | | | | | | |
| | Starch, 12629-82) | | | | | | | |
| Deposition | Polydiallyldimethylammonium | — | — | — | — | 1.07 | — | — |
| Aid | Chloride (terpolymers with mole | | | | | | | |
| | ratio of 90% polyacrylamide/5% | | | | | | | |
| | acrylic acid/5% methylenebis- | | | | | | | |
| | acrylamide-methacrylamido- | | | | | | | |
| | propyl trimethylammonium | | | | | | | |
| | chloride) (Nalco, TX12528SQ, | | | | | | | |
| | Merquat 5300) | | | | | | | |
| Deposition | Polydiallyldimethylammonium | — | — | — | — | — | — | — |
| Aid | Chloride (MW 150,000 Daltons) | | | | | | | |
| | (Nalco, Merquat 100) | | | | | | | |
| Cationic | Alkyl (C₈-C₂₀) dimethyl hydroxyl | — | — | — | — | — | — | — |
| booster | ethyl ammonia chloride, (Clariant, | | | | | | | |
| | Praepagen 3996) | | | | | | | |
| Cationic | Ditallow dimethyl ammonia | — | — | — | — | — | 1.07 | — |
| booster | chloride (Fluka, Arquad 2HT-75) | | | | | | | |
| Cationic | Coconut trimethyl ammonium | — | — | — | — | — | — | 1.07 |
| booster | chloride | | | | | | | |
| Cationic | Lauryl trimethyl ammonium | — | — | — | — | — | — | — |
| booster | chloride | | | | | | | |
| Dispersant | Tallow alkyl ethoxylate (TAE 80, | — | — | — | — | — | — | — |
| | approx. 80 molar proportions of | | | | | | | |
| | ethylene oxide) | | | | | | | |

| | | | | | | | |
|---|---|---|---|---|---|---|---|
| T2W (seconds) | 0 | 6 | 2 | 280 | 12 | 330 | 354 |

| | | Form. | Form. | Form. | Form. | Form. | Form. |
|---|---|---|---|---|---|---|---|
| Class | Material | 5 | 6 | 7 | 8 | 9 | 10 |
| Emulsion | Emulsified Polyorganosiloxane | 10.7 | 10.7 | — | — | — | — |
| Mixture | fluid-silicone resin mixture from | | | | | | |
| | above Example 1.2 (Emulsion 2) | | | | | | |
| Emulsion | Emulsified Polyorganosiloxane | — | — | 10.7 | 12 | 16 | 8 |
| Mixture | fluid-silicone resin mixture from | | | | | | |
| | above example 1.1 (Emulsion 1) | | | | | | |
| Deposition | Cationic Hydroxyl Ethyl Cellulose | 1.8 | — | — | — | — | — |
| Aid | (MW 400,000 Daltons, charge | | | | | | |
| | density 1.25 meq/g) (Dow, Cat | | | | | | |
| | HEC polymer PK) | | | | | | |
| Deposition | Cationic Starch (Maize, MW | — | — | 1.8 | 1.2 | 1.6 | 1 |
| Aid | 1,500,000 Daltons, charge density | | | | | | |
| | 0.42 meq/g, amylase 28%) (Akzo, | | | | | | |
| | EXP 5617-2301-28) (National | | | | | | |
| | Starch, 12629-82) | | | | | | |
| Deposition | Polydiallyldimethylammonium | — | — | — | — | — | — |
| Aid | Chloride (terpolymers with mole | | | | | | |
| | ratio of 90% polyacrylamide/5% | | | | | | |
| | acrylic acid/5% methylenebis- | | | | | | |
| | acrylamide-methacrylamido- | | | | | | |
| | propyl trimethylammonium | | | | | | |
| | chloride) (Nalco, TX12528SQ, | | | | | | |
| | Merquat 5300) | | | | | | |
| Deposition | Polydiallyldimethylammonium | — | 1.8 | — | — | — | — |
| Aid | Chloride (MW 150,000 Daltons) | | | | | | |
| | (Nalco, Merquat 100) | | | | | | |
| Cationic | Alkyl (C₈-C₂₀) dimethyl hydroxyl | — | 1.07 | — | — | — | — |
| booster | ethyl ammonia chloride, (Clariant, | | | | | | |
| | Praepagen 3996) | | | | | | |
| Cationic | Ditallow dimethyl ammonia | — | — | — | — | — | — |
| booster | chloride (Fluka, Arquad 2HT-75) | | | | | | |
| Cationic | Coconut trimethyl ammonium | — | — | — | — | — | — |
| booster | chloride | | | | | | |
| Cationic | Lauryl trimethyl ammonium | 1.07 | — | — | — | — | — |
| booster | chloride | | | | | | |
| Dispersant | Tallow alkyl ethoxylate (TAE 80, | — | — | — | 0.1 | 0.4 | 0.2 |
| | approx. 80 molar proportions of | | | | | | |
| | ethylene oxide) | | | | | | |

| | | | | | | |
|---|---|---|---|---|---|---|
| T2W (seconds) | 326 | 111 | 687 | 78 | 483 | 16 |

Additional liquid laundry additive compositions 11-19 detailed in Table 2 below have detailed percentages based on 100% active basis.

TABLE 2

| Ingredient | 11 | 12 | 13 | 14 | 15 | 16 | 17 | 18 | 19 |
|---|---|---|---|---|---|---|---|---|---|
| Dosage | 30 g | 30 g | 30 g | 30 g | 30 g | 30 g | 30 g | 30 g | 30 g |
| Wacker HC306 | 6.00% | 6.00% | 6.00% | 6.00% | 6.00% | 12.00% | 12.00% | 12.00% | 12.00% |
| Akzo Nobel | 1.20% | 1.20% | 1.20% | 1.20% | 1.20% | 1.20% | 1.20% | 1.20% | 1.20% |
| EXP5617 | | | | | | | | | |
| TAE80 | 0.25% | 0.25% | 0.25% | 0.25% | 0.25% | 0.25% | 0.25% | 0.25% | 0.25% |
| Proxel GXL | 0.02% | 0.02% | 0.02% | 0.02% | 0.02% | 0.02% | 0.02% | 0.02% | 0.02% |
| Best B perfume | 0.40% | 0.40% | 0.40% | 0.40% | 0.40% | 0.40% | 0.40% | 0.40% | 0.40% |
| Butyl Carbitol | 3.00% | 3.00% | 3.00% | 3.00% | 3.00% | 2.00% | 2.00% | 2.00% | 2.00% |
| Polyamine N- | 0.00% | 0.83% | 1.67% | 3.34% | 5.00% | 0.00% | 1.67% | 3.34% | 5.00% |
| oxide | | | | | | | | | |
| T2W (sec.) | 7 | 14 | 37 | 73 | 78 | 15 | 75 | 149 | 282 |

### Example 6

### Liquid Detergent Compositions

The treatment or cleaning compositions herein, such as, but not limited to liquid detergent compositions, may take the form of an aqueous solution or uniform dispersion or suspension of surfactant and water, aqueous polyorganosiloxane-silicone resin mixture, and certain optional adjunct ingredients, some of which may normally be in solid form, that have been combined with the normally liquid components of the composition. Suitable surfactants may be anionic, nonionic, cationic, zwitterionic and/or amphoteric surfactants. In one embodiment, the cleaning composition comprises anionic surfactant, nonionic surfactant, or mixtures thereof.

Suitable anionic surfactants may be any of the conventional anionic surfactant types typically used in cleaning compositions, such as liquid or solid detergent products. Such surfactants include the alkyl benzene sulfonic acids and their salts as well as alkoxylated or non-alkoxylated alkyl sulfate materials. Exemplary anionic surfactants are the alkali metal salts of C₁₀-C₁₆ alkyl benzene sulfonic acids, preferably C₁₁-C₁₄ alkyl benzene sulfonic acids. In one aspect, the alkyl group is linear. Such linear alkyl benzene sulfonates are known as “LAS”. Such surfactants and their preparation are described for example in U.S. Pat. Nos. 2,220,099 and 2,477,383. Especially preferred are the sodium and potassium linear straight chain alkylbenzene sulfonates in which the average number of carbon atoms in the alkyl group is from about 11 to 14. Sodium C₁₁-C₁₄, e.g., C₁₂ LAS is a specific example of such surfactants.

Another exemplary type of anionic surfactant comprises ethoxylated alkyl sulfate surfactants. Such materials, also known as alkyl ether sulfates or alkyl polyethoxylate sulfates, are those which correspond to the formula: R—O—(C₂H₄O)ₙ—SO₃M wherein R′ is a C₈-C₂₀ alkyl group, n is from about 1 to 20, and M is a salt-forming cation. In a specific embodiment, R′ is C₁₀-C₁₈ alkyl, n is from about 1 to 15, and M is sodium, potassium, ammonium, alkylammonium, or alkanolammonium. In more specific embodiments, R′ is a C₁₂-C₁₆, n is from about 1 to 6, and M is sodium.

The alkyl ether sulfates will generally be used in the form of mixtures comprising varying R′ chain lengths and varying degrees of ethoxylation. Frequently such mixtures will inevitably also contain some non-ethoxylated alkyl sulfate materials, i.e., surfactants of the above ethoxylated alkyl sulfate formula wherein n=0. Non-ethoxylated alkyl sulfates may also be added separately to the cleaning compositions of this disclosure and used as or in any anionic surfactant component which may be present. Specific examples of non-alkoxylated, e.g., non-ethoxylated, alkyl ether sulfate surfactants are those produced by the sulfation of higher C₈-C₂₀ fatty alcohols. Conventional primary alkyl sulfate surfactants have the general formula: R″OSO₃⁻M⁺ wherein R″ is typically a linear C₈-C₂₀ hydrocarbyl group, which may be straight chain or branched chain, and M is a water-solubilizing cation. In specific embodiments, R″ is a C₁₀-C₁₅ alkyl, and M is alkali metal, more specifically R″ is C₁₂-C₁₄ and M is sodium.

Specific, nonlimiting examples of anionic surfactants useful herein include: a) C₁₁-C₁₈ alkyl benzene sulfonates (LAS); b) C₁₀-C₂₀ primary, branched-chain and random alkyl sulfates (AS); c) C₁₀-C₁₈ secondary (2,3)-alkyl sulfates having Formulae (XIV) and (XV):

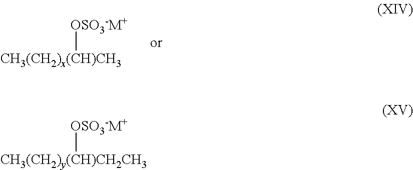

wherein M in Formulae (XIZ) and (XV) is hydrogen or a cation which provides charge neutrality, and all M units, whether associated with a surfactant or adjunct ingredient, can either be a hydrogen atom or a cation depending upon the form isolated by the artisan or the relative pH of the system wherein the compound is used, with non-limiting examples of preferred cations including sodium, potassium, ammonium, and mixtures thereof, and x in Formula XIV is an integer of at least about 7, preferably at least about 9, and y in Formula XV is an integer of at least 8, preferably at least about 9; d) C₁₀-C₁₈ alkyl alkoxy sulfates (AEₓS) wherein preferably x in Formula XIV is from 1-30; e) C₁₀-C₁₈ alkyl alkoxy carboxylates preferably comprising 1-5 ethoxy units; f) mid-chain branched alkyl sulfates as discussed in U.S. Pat. Nos. 6,020,303 and 6,060,443; g) mid-chain branched alkyl alkoxy sulfates as discussed in U.S. Pat. Nos. 6,008,181 and 6,020,303; h) modified alkylbenzene sulfonate (MLAS) as discussed in WO 99/05243, WO 99/05242, WO 99/05244, WO 99/05082, WO 99/05084, WO 99/05241, WO 99/07656, WO 00/23549, and WO 00/23548; i) methyl ester sulfonate (MES); and j) alpha-olefin sulfonate (AOS).

Suitable nonionic surfactants useful herein can comprise any of the conventional nonionic surfactant types typically used in liquid detergent products. These include alkoxylated fatty alcohols and amine oxide surfactants. Preferred for use in the liquid detergent products herein are those nonionic surfactants which are normally liquid. Suitable nonionic surfactants for use herein include the alcohol alkoxylate nonionic surfactants. Alcohol alkoxylates are materials which correspond to the general formula: R⁷(CₘH₂ₘO)ₙOH wherein R⁷ is a C₈-C₁₆ alkyl group, m is from 2 to 4, and n ranges from about 2 to 12. Preferably R⁷ is an alkyl group, which may be primary or secondary, that contains from about 9 to 15 carbon atoms, more preferably from about 10 to 14 carbon atoms. In one embodiment, the alkoxylated fatty alcohols will also be ethoxylated materials that contain from about 2 to 12 ethylene oxide moieties per molecule, more preferably from about 3 to 10 ethylene oxide moieties per molecule.

The alkoxylated fatty alcohol materials useful in the liquid detergent compositions herein will frequently have a hydrophilic-lipophilic balance (HLB) which ranges from about 3 to 17. More preferably, the HLB of this material will range from about 6 to 15, most preferably from about 8 to 15. Alkoxylated fatty alcohol nonionic surfactants have been marketed under the tradename NEODOL® by the Shell Chemical Company.

Another suitable type of nonionic surfactant useful herein comprises the amine oxide surfactants. Amine oxides are materials which are often referred to in the art as “semi-polar” nonionics. Amine oxides have the formula: R′″(EO)ₓ(PO)_{y}(BO)_{z}N(O)(CH₂R′)₂.qH₂O. In this formula, R′″ is a relatively long-chain hydrocarbyl moiety which can be saturated or unsaturated, linear or branched, and can contain from 8 to 20, preferably from 10 to 16 carbon atoms, and is more preferably C₁₂-C₁₆ primary alkyl. R′ is a short-chain moiety, preferably selected from hydrogen, methyl and —CH₂OH. When x+y+z is different from 0, EO is ethyleneoxy, PO is propyleneneoxy and BO is butyleneoxy. Amine oxide surfactants are illustrated by C₁₂-C₁₄ alkyldimethyl amine oxide.

Non-limiting examples of nonionic surfactants include: a) C₁₂-C₁₈ alkyl ethoxylates, such as, NEODOL® nonionic surfactants; b) C₆-C₁₂ alkyl phenol alkoxylates wherein the alkoxylate units are a mixture of ethyleneoxy and propyleneoxy units; c) C₁₂-C₁₈ alcohol and C₆-C₁₂ alkyl phenol condensates with ethylene oxide/propylene oxide block polymers such as PLURONIC® from BASF; d) C₁₄-C₂₂ mid-chain branched alcohols, BA, as discussed in U.S. Pat. No. 6,150,322; e) C₁₄-C₂₂ mid-chain branched alkyl alkoxylates, BAEₓ, wherein x is 1-30, as discussed in U.S. Pat. Nos. 6,153,577; 6,020,303; and 6,093,856; f) alkylpolysaccharides as discussed in U.S. Pat. No. 4,565,647; specifically alkylpolyglycosides as discussed in U.S. Pat. Nos. 4,483,780 and 4,483,779; g) polyhydroxy fatty acid amides as discussed in U.S. Pat. No. 5,332,528; WO 92/06162; WO 93/19146; WO 93/19038; and WO 94/09099; and h) ether capped poly(oxyalkylated) alcohol surfactants as discussed in U.S. Pat. No. 6,482,994 and WO 01/42408.

In the laundry detergent compositions and other cleaning compositions herein, the detersive surfactant component may comprise combinations of anionic and nonionic surfactant materials. When this is the case, the weight ratio of anionic to nonionic will typically range from 10:90 to 90:10, more typically from 30:70 to 70:30.

Cationic surfactants are well known in the art and non-limiting examples of these include quaternary ammonium surfactants, which can have up to 26 carbon atoms.

Additional examples include a) alkoxylate quaternary ammonium (AQA) surfactants as discussed in U.S. Pat. No. 6,136,769; b) dimethyl hydroxyethyl quaternary ammonium as discussed in U.S. Pat. No. 6,004,922; c) polyamine cationic surfactants as discussed in WO 98/35002; WO 98/35003; WO 98/35004; WO 98/35005; and WO 98/35006; d) cationic ester surfactants as discussed in U.S. Pat. Nos. 4,228,042; 4,239,660; 4,260,529; and 6,022,844; and e) amino surfactants as discussed in U.S. Pat. No. 6,221,825 and WO 00/47708, specifically amido propyldimethyl amine (APA).

Non-limiting examples of zwitterionic surfactants include: derivatives of secondary and tertiary amines, derivatives of heterocyclic secondary and tertiary amines, or derivatives of quaternary ammonium, quaternary phosphonium or tertiary sulfonium compounds. See U.S. Pat. No. 3,929,678 at column 19, line 38 through column 22, line 48, for examples of zwitterionic surfactants; betaine, including alkyl dimethyl betaine and cocodimethyl amidopropyl betaine, C₈-C₁₈ (preferably C₁₂-C₁₈) amine oxides and sulfo and hydroxy betaines, such as N-alkyl-N,N-dimethylammino-1-propane sulfonate where the alkyl group can be C₈-C₁₈, preferably C₁₀-C₁₄.

Non-limiting examples of ampholytic surfactants include: aliphatic derivatives of secondary or tertiary amines, or aliphatic derivatives of heterocyclic secondary and tertiary amines in which the aliphatic radical can be straight- or branched-chain. One of the aliphatic substituents contains at least about 8 carbon atoms, typically from about 8 to about 18 carbon atoms, and at least one contains an anionic water-solubilizing group, e.g. carboxy, sulfonate, sulfate. See U.S. Pat. No. 3,929,678 at column 19, lines 18-35, for examples of ampholytic surfactants.

The cleaning compositions disclosed herein may be prepared by combining the components thereof in any convenient order and by mixing, e.g., agitating, the resulting component combination to form a phase stable cleaning composition. In one aspect, a liquid matrix is formed containing at least a major proportion, or even substantially all, of the liquid components, e.g., nonionic surfactant, the non-surface active liquid carriers and other optional liquid components, with the liquid components being thoroughly admixed by imparting shear agitation to this liquid combination. For example, rapid stifling with a mechanical stirrer may usefully be employed. While shear agitation is maintained, substantially all of any anionic surfactant and the solid ingredients can be added. Agitation of the mixture is continued, and if necessary, can be increased at this point to form a solution or a uniform dispersion of insoluble solid phase particulates within the liquid phase. After some or all of the solid-form materials have been added to this agitated mixture, particles of any enzyme material to be included, e.g., enzyme prills are incorporated. As a variation of the composition preparation procedure described above, one or more of the solid components may be added to the agitated mixture as a solution or slurry of particles premixed with a minor portion of one or more of the liquid components. After addition of all of the composition components, agitation of the mixture is continued for a period of time sufficient to form compositions having the requisite viscosity and phase stability characteristics. Frequently this will involve agitation for a period of from about 30 to 60 minutes.

In another aspect of producing liquid cleaning compositions, the aqueous polyorganosiloxane-silicone resin mixture may first be combined with one or more liquid components to form a aqueous polyorganosiloxane-silicone resin mixtureaqueous polyorganosiloxane-silicone resin mixture premix, and this aqueous polyorganosiloxane-silicone resin mixtureaqueous polyorganosiloxane-silicone resin mixture premix is added to a composition formulation containing a substantial portion, for example more than 50% by weight, more than 70% by weight, or even more than 90% by weight, of the balance of components of the cleaning composition. For example, in the methodology described above, both the aqueous polyorganosiloxane-silicone resin mixtureaqueous polyorganosiloxane-silicone resin mixture premix and the enzyme component are added at a final stage of component additions. In another aspect, the aqueous polyorganosiloxane-silicone resin mixtureaqueous polyorganosiloxane-silicone resin mixture is encapsulated prior to addition to the detergent composition, the encapsulated aqueous polyorganosiloxane-silicone resin mixtureaqueous polyorganosiloxane-silicone resin mixture is suspended in a structured liquid, and the suspension is added to a composition formulation containing a substantial portion of the balance of components of the cleaning composition.

### Heavy Duty Liquid Laundry Detergent Formulations

In this Example, three sample formulations for a heavy duty liquid (HDL) laundry detergent are prepared using the aqueous polyorganosiloxane-silicone resin mixture according to embodiments of the present disclosure. The aqueous polyorganosiloxane-silicone resin mixture is added to the formulations in an amount ranging from 0.5% to 10.0% by weight.

| | A | B | C | D | E |
|---|---|---|---|---|---|
| Ingredient | Wt % | Wt % | Wt % | Wt % | Wt % |
| Sodium alkyl ether | 20.5 | 20.5 | 20.5 | | |
| sulfate | | | | | |
| C12-15 Alkyl | | | | 9.0 | |
| Polyethoxylate (1.1) | | | | | |
| Sulfonic Acid | | | | | |
| Branched alcohol sulfate | 5.8 | 5.8 | 5.8 | | |
| Linear alkylbenzene | 2.5 | 2.5 | 2.5 | 1.0 | 8.0 |
| sulfonic acid | | | | | |
| Alkyl ethoxylate | 0.8 | 0.8 | 0.8 | 1.5 | 6.0 |
| Amine oxide | 0 | 0.5 | 2 | | 1.0 |
| Citric acid | 3.5 | 3.5 | 3.5 | 2.0 | 2.5 |
| Fatty acid | 2.0 | 2.0 | 2.0 | | 5.5 |
| Protease | 0.7 | 0.7 | 0.7 | 0.4 | 0.4 |
| Amylase | 0.37 | 0.37 | 0.37 | 0.08 | 0.08 |
| Mannanase | | | | 0.03 | 0.03 |
| Borax (38%) | 3.0 | 3.0 | 3.0 | 1.0 | |
| MEA Borate | | | | | 1.5 |
| Calcium and sodium | 0.22 | 0.22 | 0.22 | 0.7 | |
| formate | | | | | |
| Amine ethoxylate | 1.2 | 0.5 | 1.0 | 1.0 | 1.5 |
| polymers | | | | | |
| Zwitterionic amine | 1.0 | 2.0 | 1.0 | | |
| ethoxylate polymer | | | | | |
| Polyorgano siloxane | 0.5 | 1.0 | 2.0 | 1.0 | 1.0 |
| Fluid-Silicone Resin | | | | | |
| Emulsion¹ | | | | | |
| DTPA² | 0.25 | 0.25 | 0.25 | 0.3 | 0.3 |
| Fluorescent whitening | 0.2 | 0.2 | 0.2 | | |
| agent | | | | | |
| Ethanol | 2.9 | 2.9 | 2.9 | 1.5 | 1.5 |
| Propylene Glycol | | | | 3.0 | 5.0 |
| Propanediol | 5.0 | 5.0 | 5.0 | | |
| Diethylene glycol | 2.56 | 2.56 | 2.56 | | |
| Polyethylene glycol 4000 | 0.11 | 0.11 | 0.11 | | |
| Monoethanolamine | 2.7 | 2.7 | 2.7 | 1.0 | 0.5 |
| Sodium hydroxide (50%) | 3.67 | 3.67 | 3.67 | 1.4 | 1.4 |
| Sodium cumene | 0 | 0.5 | 1 | | 0.7 |
| sulfonate | | | | | |
| Silicone suds suppressor | 0.01 | 0.01 | 0.01 | | 0.02 |
| Perfume | 0.5 | 0.5 | 0.5 | 0.30 | 0.3 |
| Dye | 0.01 | 0.01 | 0.01 | 0.016 | 0.016 |
| Opacifier³ | 0.01 | 0.01 | 0.01 | | |
| Water | balance | balance | balance | balance | balance |
| | 100.0% | 100.0% | 100.0% | 100.0% | 100.0% |

¹Polyorganosiloxane Fluid-Silicone Resin Emulsion - Any of example Emulsions 1, 2, 9 or 10
²Diethylenetriaminepentaacetic acid, sodium salt
³Acusol ® OP 301

### Example 7

### Granular Laundry Detergent Compositions

In another aspect of the present disclosure, the fabric care compositions disclosed herein, may take the form of granular laundry detergent compositions. Such compositions comprise the dispersant polymer of the present disclosure to provide soil and stain removal and anti-redeposition, suds boosting, and/or soil release benefits to fabric washed in a solution containing the detergent. Typically, the granular laundry detergent compositions are used in washing solutions at a level of from about 0.0001% to about 0.05%, or even from about 0.001% to about 0.01% by weight of the washing solution.

Detergent compositions may be in the form of a granule. Typical components of granular detergent compositions include but are not limited to surfactants, builders, bleaches, bleach activators and/or other bleach catalysts and/or boosters, enzymes, enzyme stabilizing agents, soil suspending agents, soil release agents, pH adjusting agents and/or other electrolytes, suds boosters or suds suppressers, anti-tarnish and anticorrosion agents, non-builder alkalinity sources, chelating agents, organic and inorganic fillers, solvents, hydrotropes, clays, silicones, flocculant, dye transfer inhibitors, photobleaches, fabric integrity agents, effervesence-generating agents, processing aids (non-limiting examples of which include binders and hydrotropes), germicides, brighteners, dyes, and perfumes. Granular detergent compositions typically comprise from about 1% to 95% by weight of a surfactant. Detersive surfactants utilized can be of the anionic, nonionic, cationic, zwitterionic, ampholytic, amphoteric, or catanionic type or can comprise compatible mixtures of these types.

Granular detergents can be made by a wide variety of processes, non-limiting examples of which include spray drying, agglomeration, fluid bed granulation, marumarisation, extrusion, or a combination thereof. Bulk densities of granular detergents generally range from about 300 g/l-1000 g/l. The average particle size distribution of granular detergents generally ranges from about 250 microns-1400 microns.

Granular detergent compositions of the present disclosure may include any number of conventional detergent ingredients. For example, the surfactant system of the detergent composition may include anionic, nonionic, zwitterionic, ampholytic and cationic classes and compatible mixtures thereof. Detergent surfactants for granular compositions are described in U.S. Pat. Nos. 3,664,961 and 3,919,678. Cationic surfactants include those described in U.S. Pat. Nos. 4,222,905 and 4,239,659.

Non-limiting examples of surfactant systems include the conventional C₁₁-C₁₈ alkyl benzene sulfonates (“LAS”) and primary, branched-chain and random C₁₀-C₂₀ alkyl sulfates (“AS”), the C₁₀-C₁₈ secondary (2,3) alkyl sulfates of the formula CH₃(CH₂)ₓ(CHOSO₃⁻M⁺)CH₃ and CH₃(CH₂)_{y}(CHOSO₃⁻M⁺)CH₂CH₃ where x and (y+1) are integers of at least about 7, preferably at least about 9, and M is a water-solubilizing cation, especially sodium, unsaturated sulfates such as oleyl sulfate, the C₁₀-C₁₈ alkyl alkoxy sulfates (“AEₓS”; especially EO 1-7 ethoxy sulfates), C₁₀-C₁₈ alkyl alkoxy carboxylates (especially the EO 1-5 ethoxycarboxylates), the C₁₀-C₁₈ glycerol ethers, the C₁₀-C₁₈ alkyl polyglycosides and their corresponding sulfated polyglycosides, and C₁₂-C₁₈ alpha-sulfonated fatty acid esters. If desired, the conventional nonionic and amphoteric surfactants such as the C₁₂-C₁₈ alkyl ethoxylates (“AE”) including the so-called narrow peaked alkyl ethoxylates and C₆-C₁₂ alkyl phenol alkoxylates (especially ethoxylates and mixed ethoxy/propoxy), C₁₂-C₁₈ betaines and sulfobetaines (“sultaines”), C₁₀-C₁₈ amine oxides, and the like, can also be included in the surfactant system. The C₁₀-C₁₈ N-alkyl polyhydroxy fatty acid amides can also be used. See WO 92/06154. Other sugar-derived surfactants include the N-alkoxy polyhydroxy fatty acid amides, such as C₁₀-C₁₈ N-(3-methoxypropyl) glucamide. The N-propyl through N-hexyl C₁₂-C₁₈ glucamides can be used for low sudsing. C₁₀-C₂₀ conventional soaps may also be used. If high sudsing is desired, the branched-chain C₁₀-C₁₆ soaps may be used. Mixtures of anionic and nonionic surfactants are especially useful. Other conventional useful surfactants are listed in standard texts.

The cleaning composition can, and in certain embodiments preferably does, include a detergent builder. Builders are generally selected from the various water-soluble, alkali metal, ammonium or substituted ammonium phosphates, polyphosphates, phosphonates, polyphosphonates, carbonates, silicates, borates, polyhydroxy sulfonates, polyacetates, carboxylates, and polycarboxylates. Preferred are the alkali metals, especially sodium, salts of the above. Preferred for use herein are the phosphates, carbonates, silicates, C₁₀-C₁₈ fatty acids, polycarboxylates, and mixtures thereof. More preferred are sodium tripolyphosphate, tetrasodium pyrophosphate, citrate, tartrate mono- and di-succinates, sodium silicate, and mixtures thereof.

Specific examples of inorganic phosphate builders are sodium and potassium tripolyphosphate, pyrophosphate, polymeric metaphosphate having a degree of polymerization of from about 6 to 21, and orthophosphates. Examples of polyphosphonate builders are the sodium and potassium salts of ethylene diphosphonic acid, the sodium and potassium salts of ethane 1-hydroxy-1,1-diphosphonic acid and the sodium and potassium salts of ethane-1,1,2-triphosphonic acid. Other phosphorus builder compounds are disclosed in U.S. Pat. Nos. 3,159,581; 3,213,030; 3,422,021; 3,422,137; 3,400,176; and 3,400,148. Examples of non-phosphorus, inorganic builders are sodium and potassium carbonate, bicarbonate, sesquicarbonate, tetraborate decahydrate, and silicates having a weight ratio of SiO₂ to alkali metal oxide of from about 0.5 to about 4.0, preferably from about 1.0 to about 2.4. Water-soluble, non-phosphorus organic builders useful herein include the various alkali metal, ammonium and substituted ammonium polyacetates, carboxylates, polycarboxylates and polyhydroxy sulfonates. Examples of polyacetate and polycarboxylate builders are the sodium, potassium, lithium, ammonium and substituted ammonium salts of ethylene diamine tetraacetic acid, nitrilotriacetic acid, oxydisuccinic acid, mellitic acid, benzene polycarboxylic acids, and citric acid.

Polymeric polycarboxylate builders are set forth in U.S. Pat. No. 3,308,067. Such materials include the water-soluble salts of homo- and copolymers of aliphatic carboxylic acids such as maleic acid, itaconic acid, mesaconic acid, fumaric acid, aconitic acid, citraconic acid and methylenemalonic acid. Some of these materials are useful as the water-soluble anionic polymer as hereinafter described, but only if in intimate admixture with the non-soap anionic surfactant. Other suitable polycarboxylates for use herein are the polyacetal carboxylates described in U.S. Pat. Nos. 4,144,226 and 4,246,495.

Water-soluble silicate solids represented by the formula SiO₂.M₂O, M being an alkali metal, and having a SiO₂:M₂O weight ratio of from about 0.5 to about 4.0, are useful salts in the detergent granules of this disclosure at levels of from about 2% to about 15% on an anhydrous weight basis. Anhydrous or hydrated particulate silicate can be utilized, as well.

Various techniques for forming cleaning compositions in such solid forms are well known in the art and may be used herein. In one aspect, when the cleaning composition, such as a fabric care composition, is in the form of a granular particle, the aqueous polyorganosiloxane-silicone resin mixture is provided in particulate form, optionally including additional but not all components of the cleaning composition. The aqueous polyorganosiloxane-silicone resin mixture particulate is combined with one or more additional particulates containing a balance of components of the cleaning composition. Further, the aqueous polyorganosiloxane-silicone resin mixture, optionally including additional but not all components of the cleaning composition may be provided in an encapsulated form, and the aqueous polyorganosiloxane-silicone resin mixture encapsulate is combined with particulates containing a substantial balance of components of the cleaning composition.

### Powder Laundry Detergent Formulations

In this Example, four sample formulations for a powder laundry detergent are prepared using the polysiloxane-silicone resin mixture according to embodiments of the present disclosure. The aqueous polyorganosiloxane-silicone resin mixture is added to the formulations in an amount ranging from 1.0% to 10.0% by weight.

| | A | B | C | D |
|---|---|---|---|---|
| Ingredients | Wt. % | Wt. % | Wt. % | Wt. % |
| Sodium alkylbenzenesulfonate | 16.0000 | 14.0000 | 12.0000 | 7.9 |
| Sodium alkyl alcohol ethoxylate | — | — | — | 4.73 |
| (3) sulfate | | | | |
| Sodium mid-cut alkyl sulfate | | 1.5000 | 1.5000 | — |
| Alkyl dimethyl hydroxyethyl | — | — | — | 0.5 |
| quaternary amine (chloride) | | | | |
| Alkyl ethoxylate | 1.3000 | 1.3000 | 1.3000 | — |
| Polyamine¹ | — | — | — | 0.79 |
| Nonionic Polymer² | 1.0000 | 1.0000 | 1.0000 | 1.0 |
| Carboxymethylcellulose | 0.2000 | 0.2000 | 0.2000 | 1.0 |
| Sodium polyacrylate | — | — | — | — |
| Sodium polyacrylate/maleate | 0.7000 | 0.7000 | 0.7000 | 3.5 |
| polymer | | | | |
| Polyorganosiloxane Fluid- | 1.0000 | 1.0000 | 1.0000 | 3.0000 |
| Silicone Resin Emulsion³ | | | | |
| Sodium tripolyphosphate | 10.0000 | 5.0000 | — | — |
| Zeolite | 16.0000 | 16.0000 | 16.0000 | — |
| Citric Acid | — | — | — | 5.0 |
| Sodium Carbonate | 12.5000 | 12.5000 | 12.5000 | 25.0 |
| Sodium Silicate | 4.0 | 4.0 | 4.0 | — |
| Enzymes⁴ | 0.30 | 0.30 | 0.30 | 0.5 |
| Minors including moisture⁵ | balance | balance | balance | balance |

¹Hexamethylenediamine ethoxylated to 24 units for each hydrogen atom bonded to a nitrogen, quaternized.
²Comb polymer of polyethylene glycol and polyvinylacetate
³Polyorganosiloxane Fluid-Silicone Resin Emulsion - Any of example Emulsions 1, 2, 9 or 10
⁴Enzyme cocktail selected from known detergent enzymes including amylase, cellulase, protease, and lipase.
⁵Balance to 100% can, for example, include minors like optical brightener, perfume, suds suppresser, soil dispersant, soil release polymer, chelating agents, bleach additives and boosters, dye transfer inhibiting agents, aesthetic enhancers (example: Speckles), additional water, and fillers, including sulfate, CaCO₃, talc, silicates, etc.

### Example 8

### Automatic Dishwasher Detergent Formulation

In this Example, five sample formulations for an automatic dishwasher detergent are prepared using the aqueous polyorganosiloxane-silicone resin mixture according to embodiments of the present disclosure. The aqueous polyorganosiloxane-silicone resin mixture is added to the formulations in an amount ranging from 0.05% to 15% by weight.

| | A | B | C | D | E |
|---|---|---|---|---|---|
| Ingredients | Wt. % | Wt. % | Wt. % | Wt. % | Wt. % |
| Polymer | 0.5 | 5 | 6 | 5 | 5 |
| dispersant¹ | | | | | |
| Carbonate | 35 | 40 | 40 | 35-40 | 35-40 |
| Sodium | 0 | 6 | 10 | 0-10 | 0-10 |
| tripoly- | | | | | |
| phosphate | | | | | |
| Silicate | 6 | 6 | 6 | 6 | 6 |
| soilds | | | | | |
| Bleach and | 4 | 4 | 4 | 4 | 4 |
| Bleach | | | | | |
| activators | | | | | |
| Enzymes | 0.3-0.6 | 0.3-0.6 | 0.3-0.6 | 0.3-0.6 | 0.3-0.6 |
| Disodium | 0 | 0 | 0 | 2-20 | 0 |
| citrate | | | | | |
| dihydrate | | | | | |
| Nonionic | 0 | 0 | 0 | 0 | 0.8-5 |
| surfactant² | | | | | |
| Polyorgano- | 0.05-15 | 0.05-15 | 0.05-15 | 0.05-15 | 0.05-15 |
| siloxane | | | | | |
| Fluid- | | | | | |
| Silicone | | | | | |
| Resin | | | | | |
| Emulsion³ | | | | | |
| Water, | Balance | Balance | Balance | Balance to | Balance to |
| sulfate, | to 100% | to 100% | to 100% | 100% | 100% |
| perfume, | | | | | |
| dyes and | | | | | |
| other | | | | | |
| adjuncts | | | | | |

¹Anionic polymers such as Acusol ®, Alcosperse ® and other modified polyacrylic acid polymers.
²Such as SLF-18 polytergent from Olin Corporation
³Polyorganosiloxane Fluid-Silicone Resin Emulsion - Any of example Emulsions 1, 2, 9 or 10

### Example 9

### Liquid Dishwashing Liquid

### Liquid Dish Handwashing Detergents

| Composition | A | B |
|---|---|---|
| C₁₂₋₁₃ Natural AE0.6S | 270 | 240 |
| C₁₀₋₁₄ mid-branched Amine Oxide | — | 6.0 |
| C₁₂₋₁₄ Linear Amine Oxide | 6.0 | — |
| SAFOL ® 23 Amine Oxide | 1.0 | 1.0 |
| C₁₁E₉ Nonionic¹ | 2.0 | 2.0 |
| Ethanol | 4.5 | 4.5 |
| Sodium cumene sulfonate | 1.6 | 1.6 |
| Polypropylene glycol 2000 | 0.8 | 0.8 |
| NaCl | 0.8 | 0.8 |
| 1,3 BAC Diamine² | 0.5 | 0.5 |
| Polyorganosiloxane Fluid-Silicone | 0.05-15 | 0.05-15 |
| Resin Emulsion³ | | |
| Water | Balance | Balance |

¹Nonionic may be either C₁₁ Alkyl ethoxylated surfactant containing 9 ethoxy groups.
²1,3, BAC is 1,3 bis(methylamine)-cyclohexane.
³Polyorganosiloxane Fluid-Silicone Resin Emulsion - Any of example Emulsions 1, 2, 9 or 10

### Example 10

### Unit Dose

The detergent product of the present invention may comprise a water-soluble pouch, more preferably a multi-compartment water-soluble pouch. Such a pouch comprises a water-soluble film and at least a first, and optionally a second compartment. The first compartment comprises a first composition, comprising an opacifier and an antioxidant. The second compartment comprises a second compartment. Preferably the pouch comprises a third compartment and a third composition. The optionally second and third compositions are preferably visibly distinct from each other and the first composition.

Optionally, a difference in aesthetic appearance may be achieved in a number of ways. However the first compartment of the pouch may comprise an opaque liquid composition. The compartments of the pouch may be the same size or volume. Alternatively, the compartments of the pouch may have different sizes, with different internal volumes.

The compartments may also be different from one another in terms of texture. Hence one compartment may be glossy, while the other is matt. This can be readily achieved as one side of a water-soluble film is often glossy, while the other has a matt finish. Alternatively the film used to make a compartment may be treated in a way so as to emboss, engrave or print the film. Embossing may be achieved by adhering material to the film using any suitable means described in the art. Engraving may be achieved by applying pressure onto the film using any suitable technique available in the art. Printing may be achieved using any suitable printer and process available in the art. Alternatively, the film itself may be colored, allowing the manufacturer to select different colored films for each compartment. Alternatively the films may be transparent or translucent and the composition contained within may be colored.

Unit dose compositions may have compartments which can be separate, but are preferably conjoined in any suitable manner. Most preferably the second and optionally third or subsequent compartments are superimposed on the first compartment. In one embodiment, the third compartment may be superimposed on the second compartment, which is in turn superimposed on the first compartment in a sandwich configuration. Alternatively the second and third compartments are superimposed on the first compartment. However it is also equally envisaged that the first, second and optionally third and subsequent compartments may be attached to one another in a side by side relationship. The compartments may be packed in a string, each compartment being individually separable by a perforation line. Hence each compartment may be individually torn-off from the remainder of the string by the end-user, for example, so as to pre-treat or post-treat a fabric with a composition from a compartment.

In a preferred embodiment the pouch may comprise three compartments consisting of a large first compartment and two smaller compartments. The second and third smaller compartments are superimposed on the first larger compartment. The size and geometry of the compartments are chosen such that this arrangement is achievable.

The geometry of the compartments may be the same or different. In a preferred embodiment the second and optionally third compartment have a different geometry and shape to the first compartment. In this embodiment the second and optionally third compartments are arranged in a design on the first compartment. Said design may be decorative, educative, illustrative for example to illustrate a concept or instruction, or used to indicate origin of the product. In a preferred embodiment the first compartment is the largest compartment having two large faces sealed around the perimeter. The second compartment is smaller covering less than 75%, more preferably less than 50% of the surface area of one face of the first compartment. In the embodiment wherein there is a third compartment, the above structure is the same but the second and third compartments cover less than 60%, more preferably less than 50%, even more preferably less than 45% of the surface area of one face of the first compartment.

The pouch is preferably made of a film material which is soluble or dispersible in water, and has a water-solubility of at least 50%, preferably at least 75% or even at least 95%, as measured by the method set out here after using a glass-filter with a maximum pore size of 20 microns:

50 grams±0.1 gram of pouch material is added in a pre-weighed 400 ml beaker and 245 ml±1 ml of distilled water is added. This is stirred vigorously on a magnetic stirrer set at 600 rpm, for 30 minutes. Then, the mixture is filtered through a folded qualitative sintered-glass filter with a pore size as defined above (max. 20 micron). The water is dried off from the collected filtrate by any conventional method, and the weight of the remaining material is determined (which is the dissolved or dispersed fraction). Then, the percentage solubility or dispersability can be calculated.

Preferred pouch materials are polymeric materials, preferably polymers which are formed into a film or sheet. The pouch material can, for example, be obtained by casting, blow-moulding, extrusion or blown extrusion of the polymeric material, as known in the art.

Preferred polymers, copolymers or derivatives thereof suitable for use as pouch material are selected from polyvinyl alcohols, polyvinyl pyrrolidone, polyalkylene oxides, acrylamide, acrylic acid, cellulose, cellulose ethers, cellulose esters, cellulose amides, polyvinyl acetates, polycarboxylic acids and salts, polyaminoacids or peptides, polyamides, polyacrylamide, copolymers of maleic/acrylic acids, polysaccharides including starch and gelatine, natural gums such as xanthum and carragum. More preferred polymers are selected from polyacrylates and water-soluble acrylate copolymers, methylcellulose, carboxymethylcellulose sodium, dextrin, ethylcellulose, hydroxyethyl cellulose, hydroxypropyl methylcellulose, maltodextrin, polymethacrylates, and most preferably selected from polyvinyl alcohols, polyvinyl alcohol copolymers and hydroxypropyl methyl cellulose (HPMC), and combinations thereof. Preferably, the level of polymer in the pouch material, for example a PVA polymer, is at least 60%. The polymer can have any weight average molecular weight, preferably from about 1000 to 1,000,000, more preferably from about 10,000 to 300,000 yet more preferably from about 20,000 to 150,000.

Mixtures of polymers can also be used as the pouch material. This can be beneficial to control the mechanical and/or dissolution properties of the compartments or pouch, depending on the application thereof and the required needs. Suitable mixtures include for example mixtures wherein one polymer has a higher water-solubility than another polymer, and/or one polymer has a higher mechanical strength than another polymer. Also suitable are mixtures of polymers having different weight average molecular weights, for example a mixture of PVA or a copolymer thereof of a weight average molecular weight of about 10,000-40,000, preferably around 20,000, and of PVA or copolymer thereof, with a weight average molecular weight of about 100,000 to 300,000, preferably around 150,000. Also suitable herein are polymer blend compositions, for example comprising hydrolytically degradable and water-soluble polymer blends such as polylactide and polyvinyl alcohol, obtained by mixing polylactide and polyvinyl alcohol, typically comprising about 1-35% by weight polylactide and about 65% to 99% by weight polyvinyl alcohol. Preferred for use herein are polymers which are from about 60% to about 98% hydrolysed, preferably about 80% to about 90% hydrolysed, to improve the dissolution characteristics of the material.

Naturally, different film material and/or films of different thickness may be employed in making the compartments of the present invention. A benefit in selecting different films is that the resulting compartments may exhibit different solubility or release characteristics.

Most preferred pouch materials are PVA films known under the trade reference Monosol M8630, as sold by Chris-Craft Industrial Products of Gary, Ind., US, and PVA films of corresponding solubility and deformability characteristics. Other films suitable for use herein include films known under the trade reference PT film or the K-series of films supplied by Aicello, or VF-HP film supplied by Kuraray.

The pouch material herein can also comprise one or more additive ingredients. For example, it can be beneficial to add plasticisers, for example glycerol, ethylene glycol, diethyleneglycol, propylene glycol, sorbitol and mixtures thereof. Other additives include functional detergent additives to be delivered to the wash water, for example organic polymeric dispersants, etc.

For reasons of deformability pouches or pouch compartments containing a component which is liquid will preferably contain an air bubble having a volume of up to about 50%, preferably up to about 40%, more preferably up to about 30%, more preferably up to about 20%, more preferably up to about 10% of the volume space of said compartment.

The water soluble pouch may be made using any suitable equipment and method. Single compartment pouches are made using vertical, but preferably horizontal form filling techniques commonly known in the art. The film is preferably dampened, more preferably heated to increase the malleability thereof. Even more preferably, the method also involves the use of a vacuum to draw the film into a suitable mould. The vacuum drawing the film into the mould can be applied for 0.2 to 5 seconds, preferably 0.3 to 3 or even more preferably 0.5 to 1.5 seconds, once the film is on the horizontal portion of the surface. This vacuum may preferably be such that it provides an under-pressure of between −100 mbar to −1000 mbar, or even from −200 mbar to −600 mbar.

The moulds, in which the pouches are made, can have any shape, length, width and depth, depending on the required dimensions of the pouches. The moulds can also vary in size and shape from one to another, if desirable. For example, it may be preferred that the volume of the final pouches is between 5 and 300 ml, or even 10 and 150 ml or even 20 and 100 ml and that the mould sizes are adjusted accordingly.

Heat can be applied to the film, in the process commonly known as thermoforming, by any means. For example the film may be heated directly by passing it under a heating element or through hot air, prior to feeding it onto the surface or once on the surface. Alternatively it may be heated indirectly, for example by heating the surface or applying a hot item onto the film. Most preferably the film is heated using an infra red light. The film is preferably heated to a temperature of 50 to 120° C., or even 60 to 90° C. Alternatively, the film can be wetted by any mean, for example directly by spraying a wetting agent (including water, solutions of the film material or plasticizers for the film material) onto the film, prior to feeding it onto the surface or once on the surface, or indirectly by wetting the surface or by applying a wet item onto the film.

Once a film has been heated/wetted, it is drawn into an appropriate mould, preferably using a vacuum. The filling of the molded film can be done by any known method for filling (preferably moving) items. The most preferred method will depend on the product form and speed of filling required. Preferably the molded film is filled by in-line filling techniques. The filled, open pouches are then closed, using a second film, by any suitable method. Preferably, this is also done while in horizontal position and in continuous, constant motion. Preferably the closing is done by continuously feeding a second film, preferably water-soluble film, over and onto the open pouches and then preferably sealing the first and second film together, typically in the area between the moulds and thus between the pouches.

Preferred methods of sealing include heat sealing, solvent welding, and solvent or wet sealing. It is preferred that only the area which is to form the seal, is treated with heat or solvent. The heat or solvent can be applied by any method, preferably on the closing material, preferably only on the areas which are to form the seal. If solvent or wet sealing or welding is used, it may be preferred that heat is also applied. Preferred wet or solvent sealing/welding methods include applying selectively solvent onto the area between the moulds, or on the closing material, by for example, spraying or printing this onto these areas, and then applying pressure onto these areas, to form the seal. Sealing rolls and belts as described above (optionally also providing heat) can be used, for example.

The formed pouches can then be cut by a cutting device. Cutting can be done using any known method. It may be preferred that the cutting is also done in continuous manner, and preferably with constant speed and preferably while in horizontal position. The cutting device can, for example, be a sharp item or a hot item, whereby in the latter case, the hot item ‘burns’ through the film/sealing area.

The different compartments of a multi-compartment pouch may be made together in a side-by-side style and consecutive pouches are not cut. Alternatively, the compartments can be made separately.

According to this process and preferred arrangement, the pouches are made according to the process comprising the steps of: a) forming an first compartment (as described above); b) forming a recess within some or all of the closed compartment formed in step a), to generate a second molded compartment superposed above the first compartment; c) filling and closing the second compartments by means of a third film; d) sealing said first, second and third films; and e) cutting the films to produce a multi-compartment pouch.

Said recess formed in step b) is preferably achieved by applying a vacuum to the compartment prepared in step a). Alternatively the second, and optionally third, compartment(s) can be made in a separate step and then combined with the first compartment as described in our co-pending application EP 08101442.5 which is incorporated herein by reference. A particularly preferred process comprises the steps of: a) forming a first compartment, optionally using heat and/or vacuum, using a first film on a first forming machine; b) filling said first compartment with a first composition; c) on a second forming machine, deforming a second film, optionally using heat and vacuum, to make a second and optionally third molded compartment; d) filling the second and optionally third compartments; e) sealing the second and optionally third compartment using a third film; f) placing the sealed second and optionally third compartments onto the first compartment; g) sealing the first, second and optionally third compartments; and h) cutting the films to produce a multi-compartment pouch.

The first and second forming machines are selected based on their suitability to perform the above process. The first forming machine is preferably a horizontal forming machine. The second forming machine is preferably a rotary drum forming machine, preferably located above the first forming machine.

It will be understood moreover that by the use of appropriate feed stations, it is possible to manufacture multi-compartment pouches incorporating a number of different or distinctive compositions and/or different or distinctive liquid, gel or paste compositions.

### Detergent Composition of the Unit Dose Product

At least one of the compartments of the unit dose product comprises the main wash detergent composition. One embodiment of the Unit Dose Product Detergent is shown below.

### Unit Dose Composition

| | Wt % |
|---|---|
| Glycerol (min 99) | 5.3 |
| 1,2-propanediol | 10.0 |
| Citric Acid | 0.5 |
| Monoethanolamine | 10.0 |
| Caustic soda | — |
| Dequest ® 2010 | 1.1 |
| Potassium sulfite | 0.2 |
| Nonionic Marlipal ® C24EO7 | 20.1 |
| HLAS | 24.6 |
| Optical brightener FWA49 | 0.2 |
| Polyorganosiloxane Fluid-Silicone Resin | 0.05-15 |
| Emulsion¹ | |
| C12-15 Fatty acid | 16.4 |
| Polymer Lutensit ® Z96 | 2.9 |
| Polyethyleneimine ethoxylate PEI600 E20 | 1.1 |
| MgCl2 | 0.2 |
| Enzymes | ppm |

¹Polyorganosiloxane Fluid-Silicone Resin Emulsion - Any of example Emulsions 1, 2, 9 or 10

### Processes of Making Cleaning Compositions

The cleaning compositions, such as, but not limited to, the fabric care compositions of the present disclosure can be formulated into any suitable form and prepared by any process chosen by the formulator, non-limiting examples of which are described in U.S. Pat. Nos. 5,879,584; 5,691,297; 5,574,005; 5,569,645; 5,565,422; 5,516,448; 5,489,392; and 5,486,303.

### Methods of Using Fabric Care Compositions

The fabric care compositions disclosed in the present specification may be used to clean or treat a fabric, such as those described herein. Typically at least a portion of the fabric is contacted with an embodiment of the aforementioned fabric care compositions, in neat form or diluted in a liquor, for example, a wash liquor and then the fabric may be optionally washed and/or rinsed. In one aspect, a fabric is optionally washed and/or rinsed, contacted with an embodiment of the aforementioned fabric care compositions and then optionally washed and/or rinsed. For purposes of the present disclosure, washing includes but is not limited to, scrubbing, and mechanical agitation. The fabric may comprise most any fabric capable of being laundered or treated.

The fabric care compositions disclosed in the present specification can be used to form aqueous washing solutions for use in the laundering of fabrics. Generally, an effective amount of such compositions is added to water, preferably in a conventional fabric laundering automatic washing machine, to form such aqueous laundering solutions. The aqueous washing solution so formed is then contacted, preferably under agitation, with the fabrics to be laundered therewith. An effective amount of the fabric care composition, such as the liquid detergent compositions disclosed in the present specification, may be added to water to form aqueous laundering solutions that may comprise from about 500 to about 7,000 ppm or even from about 1,000 to about 3,000 pm of fabric care composition.

In one aspect, the fabric care compositions may be employed as a laundry additive, a pre-treatment composition and/or a post-treatment composition.

While various specific embodiments have been described in detail herein, the present disclosure is intended to cover various different combinations of the disclosed embodiments and is not limited to those specific embodiments described herein. The various embodiments of the present disclosure may be better understood when read in conjunction with the following representative examples. The following representative examples are included for purposes of illustration and not limitation.

### Test Methods

### Time-to Wick (T2W) Measurement Protocol

The fabric Time to Wick property is measured as follows: The test is conducted in a room or chamber with air temperature of 20-25° C. and Relative Humidity of 50-60%. All fabrics and paper products used in the test are equilibrated in the temperature and humidity condition of the test location for 24 hrs prior to collecting measurements. On a flat, horizontal and level, impermeable surface, place 1 piece of test fabric 8 cm×10 cm in size, on top of a single sheet of kitchen paper towel (eg Bounty). The fabric surface facing upwards, which is not in contact with the paper towel, can be either side of the fabric. Visually confirm that the fabric is lying flat and in uniform contact with the paper towel before proceeding. Distilled Water is used as the testing liquid. Automated single or multi-channel pipettes (eg Rainin, Gilson, Eppendorf), are used to deliver a liquid droplet size of 300 μL of the testing liquid onto the fabric surface. A stop-watch or timer is used to count time in seconds, from the moment when the liquid droplet contacts the fabric surface. The timer is stopped when the whole droplet of the test liquid wets into the fabric. The point when the liquid droplet wets into the fabric is determined by visual observation that the liquid droplet has moved from sitting above the fabric surface to having completely penetrated into the fabric. The time period shown elapsed on the timer is the Time to Wick Measurement. The test is stopped after 20 minutes if wetting of the liquid droplet has not been seen yet. The Time to Wick measurement is recorded as >20 mins in this case. If wetting of the liquid is seen immediately upon contact of the droplet with the fabric surface, then the Time to Wick property is recorded as 0 for that fabric. Multiple repeats are performed for each test fabric. These replicates are comprised of 10 pieces of each test fabric, and 3 droplets of test liquid per piece of fabric, resulting in a total of 30 droplets being measured per test fabric. In addition to the average of the 30 Time to Wick measurements, the Standard Deviation and the 95% confidence interval should also be reported.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”.

All documents cited in the Detailed Description of the Invention are, in relevant part, incorporated herein by reference; the citation of any document is not to be construed as an admission that it is prior art with respect to the present disclosure. To the extent that any meaning or definition of a term in this document conflicts with any meaning or definition of the same term in a document incorporated by reference, the meaning or definition assigned to that term in this document shall govern.

While particular embodiments of the present disclosure have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A fabric care composition comprising an emulsion comprising:
a) a mixture comprising:
i) a hydrophobic fluid comprising silicon containing moieties or fluorine containing moieties, wherein the hydrophobic fluid is dispersible in water; and
ii) a particulate material having a particle size ranging from about 1 nm to about 10,000 nm; and
b) an amphoteric or cationic oligomeric/polymeric deposition aid.

2. The fabric care composition of claim 1, wherein the amphoteric or cationic oligomeric/polymeric deposition aid is a cationic polymer selected from the group consisting of a cationic polysaccharide, a cationic guar, a cationic lignin, a cationic polymer, an amine containing polymer, an amide containing polymer and combinations of any thereof.

3. The fabric care composition of claim 2, wherein the cationic polymer is a branched cationic polymer.

4. The fabric care composition of claim 2, wherein the cationic polymer is a branched cationic polysaccharide having a fraction of alpha-1,4 glycosidic linkages of at least 0.01 up to 1.0.

5. The fabric care composition of claim 4, wherein the branched cationic polysaccharide has at least one of a charge density ranging from about 0.001 meq/g to about 5.0 meq/gram of the polymer, and a weight average molecular weight ranging from about 500 Daltons to about 5,000,000 Daltons.

6. The fabric care composition of claim 4, wherein the branched cationic polysaccharide is a branched cationic starch.

7. The fabric care composition of claim 1, wherein the mixture is in the form of an emulsion and wherein the emulsion further comprises a diluent.

8. The fabric care composition of claim 7, wherein the diluent is water.

9. The fabric care composition of claim 7, wherein the emulsion further comprises a solvent.

10. The fabric care composition of claim 1, wherein the hydrophobic fluid comprises one or more compounds selected from a fluoropolymer, a polysiloxane, an amino silicone, a polydialkyl siloxane, organofunctional silicones, cyclic silicones, cationic silicones, a silicone elastomer, a silicone polyether, a silicone quaternary compound, a silicone phosphate, a silicone betaine, a silicone amine oxide, an alkylated silicone, a fluorinated silicone, an alkylated silicone polyether, a silicone polyether ester or carboxylate, a reactive silicone comprising one or more alcohol, isocyanate, acrylate, or vinyl group, an epoxy silicone, a silicone ester, a polyacrylate, a polymethacrylate, a polystyrene, a polyurethane, a polyester, a wax, and combinations thereof.

11. The fabric care composition of claim 1, wherein the particulate material is an inelastic solid particulate having a particle size ranging from about 5 nm to about 10,000 nm.

12. The fabric care composition of claim 11, wherein the inelastic solid particulate is a synthetic silicate or a metal oxide.

13. The fabric care composition of claim 1, wherein the particulate material is an elastic solid particulate having a particle size ranging from about 5 nm to about 100 nm.

14. The fabric care composition of claim 13, wherein the elastic solid particulate is a silicone resin selected from the group consisting of a silsesquioxane polymer, an M resin, a Q resin, a T resin, a D resin, an MQ resin, a TQ resin, and mixtures of any thereof.

15. The fabric care composition of claim 1, wherein mixture comprising the hydrophobic fluid and the particulate material is in the form of an emulsion or a suspension.

16. The fabric care composition of claim 16, wherein the emulsion or the suspension further comprises an emulsifier selected from hexyl glycol ether, an anionic surfactant, a nonionic surfactant and a cationic surfactant.

17. The fabric care composition of claim 1, wherein the hydrophobic fluid and the particulate material are combined to comprise a polysiloxane-silicone resin mixture comprising:
1) 100 parts by weight of one or more polyorganosiloxane fluid compounds, wherein each polyorganosiloxane fluid compound contain at least about 80 mol % of units selected from the group consisting of units of general formulas Ia. Ib, II, and III:
R¹₂SiO_{(2/2)} (Ia)
R¹ₐR²_{b}SiO_{(2/2)} (Ib),
R³₃SiO_{(1/2)} (II), and
R³₂R⁴SiO_{(1/2)} (III)
in which
a has a value of 0, 1, or 2; b has a value of 1, or 2; and the sum of a and b equals 2;
each R¹ is independently a hydrocarbon residue with from 1 to 40 carbon atoms and optionally substituted with one or more halogens;
each R² is an aminoalkyl residue having general formula IV:
—R⁵—NR⁶R⁷, (IV)
where each R⁵ is independently a divalent hydrocarbon residue with from 1 to 40 carbon atoms, and
a) each R⁶ is independently a monovalent hydrocarbon residue with from 1 to 40 carbon atoms, a hydrogen, a hydroxymethyl, or an alkanoyl residue; and each R⁷ is independently a residue having general formula V:
—(R⁸—NR⁶)_{X}—R⁶, (V)
where x is an integer having a value ranging from 0 to 40, and each R⁸ is independently a divalent residue having general formula VI
—(CR⁹₂)_{y}—, (VI)
where y is an integer having a value ranging from 1 to 6 and each R⁹ is independently H or a hydrocarbon residue with from 1 to 40 carbon atoms; or
b) R⁶ and R⁷ together with the N atom form a cyclic organic residue with from 3 to 8-CH₂— units and where nonadjacent —CH₂— units can optionally be replaced by a unit chosen from —C(═O)—, —NH—, —O—, and —S—;
each R³ is independently a hydrocarbon residue with from 1 to 40 carbon atoms and optionally substituted with one or more halogens; and
each R⁴ is independently —OR or —OH, where R is a hydrocarbon residue with from 1 to 40 carbon atoms and optionally substituted with one or more halogens, and
wherein the ratio of units of formula I to the sum of units of formulae II and III within the one or more polyorganosiloxane fluid compound ranges from about 0.5 to about 500,
the average ratio of units of formula II to units of formula III within the one or more polyorganosiloxane fluid compound ranges from about 1.86 to about 100, and
the one or more polyorganosiloxane fluid compounds have an average amine number of at least about 0.01 meq/g of polyorganosiloxane;
2) at least 0.01% by weight of one or more silicone resins, each of which contain at least about 80 mol % of units selected from the group consisting of units of general formulae VII, VIII, IX, and X:
R¹⁰₃SiO_{(1/2)} (VII),
R¹⁰₂SiO_{(2/2)} (VIII),
R¹⁰SiO_{(3/2)} (IX), and
SiO_{(4/2)} (X),
where each R¹⁰ is independently residues of —H, —OH, —OR, or a hydrocarbon with from 1 to 40 carbon residues and optionally substituted with one or more halogens, at least about 20 mol % of the units are selected from the group consisting of units of the general formulae IX and X, and a maximum of 10 wt % of the R¹⁰ residues are —OH and —OR residues; and
3) a maximum of 5 parts by weight of water.

18. The fabric care composition of claim 1, wherein the hydrophobic fluid and the particulate material are combined to comprise a polysiloxane-silicone resin emulsion comprising:
1) 100 parts by weight of one or more polyorganosiloxane fluid compounds, wherein each polyorganosiloxane fluid compound contain at least about 80 mol % of units selected from the group consisting of units of general formulas Ia, Ib, II, and III:
R¹₂SiO_{(2/2)} (Ia)
R¹ₐR²_{b}SiO_{(2/2)} (Ib),
R³₃SiO_{(1/2)} (II), and
R³₂R⁴SiO_{(1/2)} (III),
in which
a has a value of 0, 1, or 2; b has a value of 1, or 2; and the sum of a and b equals 2;
each R¹ is independently a hydrocarbon residue with from 1 to 40 carbon atoms and optionally substituted with one or more halogens;
each R² is an aminoalkyl residue having general formula IV:
—R⁵—NR⁶R⁷, (IV)
where each R⁵ is independently a divalent hydrocarbon residue with from 1 to 40 carbon atoms, and
a) each R⁶ is independently a monovalent hydrocarbon residue with from 1 to 40 carbon atoms, a hydrogen, a hydroxymethyl, or an alkanoyl residue; and each R⁷ is independently a residue having general formula V:
—(R⁸—NR⁶)_{X}—R⁶, (V)
where x is an integer having a value ranging from 0 to 40, and each R⁸ is independently a divalent residue having general formula VI
—(CR⁹₂)_{y}—, (VI)
where y is an integer having a value ranging from 1 to 6 and each R⁹ is independently H or a hydrocarbon residue with from 1 to 40 carbon atoms; or
b) R⁶ and R⁷ together with the N atom form a cyclic organic residue with from 3 to 8 —CH₂— units and where nonadjacent —CH₂— units can optionally be replaced by a unit chosen from —C(═O)—, —NH—, —O—, and —S—;
each R³ is independently a hydrocarbon residue with from 1 to 40 carbon atoms and optionally substituted with one or more halogens; and
each R⁴ is independently —OR or —OH, where R is a hydrocarbon residue with from 1 to 40 carbon atoms and optionally substituted with one or more halogens, and
wherein the ratio of units of formula I to the sum of units of formulae II and III within the one or more polyorganosiloxane fluid compound ranges from about 0.5 to about 500,
the average ratio of units of formula II to units of formula III within the one or more polyorganosiloxane fluid compound ranges from about 1.86 to about 100, and
the one or more polyorganosiloxane fluid compounds have an average amine number of at least about 0.01 meq/g of polyorganosiloxane;
2) at least 0.01% by weight of one or more silicone resins, each of which contain at least about 80 mol % of units selected from the group consisting of units of general formulae VII, VIII, IX, and X:
R¹⁰₃SiO_{(1/2)} (VII),
R¹⁰₂SiO_{(2/2)} (VIII),
R¹⁰SiO_{(3/2)} (IX), and
SiO_{(4/2)} (X),
where each R¹⁰ is independently residues of —H, —OH, —OR, or a hydrocarbon with from 1 to 40 carbon residues and optionally substituted with one or more halogens, at least about 20 mol % of the units are selected from the group consisting of units of the general formulae IX and X, and a maximum of 10 wt % of the R¹⁰ residues are —OH and —OR residues; and
3) at least 10 parts by weight water; and
4) optionally, less than 5 parts by weight of an emulsifier.

19. The fabric care composition of claim 1, wherein the particulate material can form cross-links with the hydrophobic fluid.

20. The fabric care composition of claim 1, further comprising one or more additives selected from the group consisting of bleach, bleach activators, surfactants, builders, chelating agents, dye transfer inhibiting agents, dispersants, enzymes, enzyme stabilizers, catalytic metal complexes, polymers, polymeric dispersing agents, clay and soil removal/anti-redeposition agents, brighteners, suds suppressors, dyes, perfumes, perfume delivery systems, structure elasticizing agents, fabric softeners, carriers, hydrotropes, solvents, processing aids, and pigments.

21. The fabric care composition of claim 1, wherein the composition is in a form selected from the group consisting of a detergent, a heavy duty liquid detergent, powder detergent, a laundry rinse additive, a pretreatment, a wash additive, a fabric enhancer, a laundry spray, a post-rinse fabric treatment, an ironing aid, a unit dose formulation, a dry cleaning composition, a delayed delivery formulation, and combinations of any thereof.

22. The fabric care composition of claim 1, further comprising a surfactant quencher in from about 0.001% to about 5.0% by weight of the composition.

23. The fabric care composition of claim 22, wherein the surfactant quencher has at least one of a solubility of from about 0.1% to about 40%, a cationic charge ranging from about 0.1 meq/g to about 23 meq/g, and a molecular weight of from about 50 g/mol to about 1000 g/mol.

24. The fabric care composition of claim 22, wherein the surfactant quencher is lauryl trimethyl ammonium chloride or ditallow dimethyl ammonium chloride (DTDMAC).

25. A fabric care composition comprising:
a) a mixture comprising:
i) a hydrophobic fluid comprising silicon containing moieties or fluorine containing moieties, wherein the hydrophobic fluid is dispersible in water; and
ii) a particulate material having a particle size ranging from about 1 nm to about 10,000 nm;
b) an amphoteric or cationic oligomeric/polymeric deposition aid; and
c) a surfactant quencher.

26. A fabric care composition comprising:
a) a mixture comprising:
i) a hydrophobic fluid comprising silicon containing moieties or fluorine containing moieties, wherein the hydrophobic fluid is dispersible in water; and
ii) a particulate material having a particle size ranging from about 1 nm to about 10,000 nm;
b) an amphoteric or cationic oligomeric/polymeric deposition aid;
c) a surfactant quencher; and
d) a dispersant aid selected from the group consisting of a non-ionic surfactant, a polymeric surfactant, a silicone-based surfactant and combinations thereof.

27. The fabric care composition of claim 26 where in the dispersant aid is selected from the group consisting of tallow alkyl ethoxylate, polyvinyl alchols, polyvinyl pyrrolidones and mixtures thereof.

28. A method for providing improved stain repellency for a textile comprising:
treating a surface of a textile with a fabric care composition comprising a mixture comprising:
a) a hydrophobic fluid;
b) a particulate material;
c) an amphoteric or cationic oligomeric/polymeric deposition aid comprising a cationic polymer selected from the group consisting of a cationic polysaccharide, a cationic guar, a cationic lignin, a cationic polymer, an amine containing polymer, an amide containing polymer, and combinations of any thereof; and
d) water,
wherein the fabric care composition deposits on at least a portion of the textile fiber surface.

29. The method of claim 28, wherein the particulate material is capable of forming crosslinks with the hydrophobic fluid, the method further comprising:
forming a plurality of crosslinks between the particle and the hydrophobic fluid.

30. The method of claim 28, wherein the mixture is a polysiloxane-silicone resin mixture comprising:
1) 100 parts by weight of one or more polyorganosiloxane fluid compounds, wherein each polyorganosiloxane fluid compound contain at least about 80 mol % of units selected from the group consisting of units of general formulas Ia, Ib, II, and III:
R¹₂SiO_{(2/2)} (Ia)
R¹ₐR²_{b}SiO_{(2/2)} (Ib),
R³₃SiO_{(1/2)} (II), and
R³₂R⁴SiO_{(1/2)} (III),
in which
a has a value of 0, 1, or 2; b has a value of 0, 1, or 2; and the sum of a and b equals 2;
each R¹ is independently a hydrocarbon residue with from 1 to 40 carbon atoms and optionally substituted with one or more halogens;
each R² is an aminoalkyl residue having general formula IV:
—R⁵—NR⁶R⁷, (IV)
where each R⁵ is independently a divalent hydrocarbon residue with from 1 to 40 carbon atoms, and
a) each R⁶ is independently a monovalent hydrocarbon residue with from 1 to 40 carbon atoms, a hydrogen, a hydroxymethyl, or an alkanoyl residue; and each R⁷ is independently a residue having general formula V:
—(R⁸—NR⁶)_{X}—R⁶, (V)
where x is an integer having a value ranging from 0 to 40, and each R⁸ is independently a divalent residue having general formula VI
—(CR⁹₂)_{y}—, (VI)
where y is an integer having a value ranging from 1 to 6 and each R⁹ is independently H or a hydrocarbon residue with from 1 to 40 carbon atoms; or
b) R⁶ and R⁷ together with the N atom form a cyclic organic residue with from 3 to 8 —CH₂— units and where nonadjacent —CH₂— units can optionally be replaced by a unit chosen from —C(═O)—, —NH—, —O—, and —S—;
each R³ is independently a hydrocarbon residue with from 1 to 40 carbon atoms and optionally substituted with one or more halogens; and
each R⁴ is independently —OR or —OH, where R is a hydrocarbon residue with from 1 to 40 carbon atoms and optionally substituted with one or more halogens, and
wherein the ratio of units of formula I to the sum of units of formulae II and III within the one or more polyorganosiloxane fluid compound ranges from about 0.5 to about 500,
the average ratio of units of formula II to units of formula III within the one or more polyorganosiloxane fluid compound ranges from about 1.86 to about 100, and
the one or more polyorganosiloxane fluid compounds have an average amine number of at least about 0.01 meq/g of polyorganosiloxane;
2) at least 0.01% by weight of one or more silicone resins, each of which contain at least about 80 mol % of units selected from the group consisting of units of general formulae VII, VIII, IX, and X:
R¹⁰₃SiO_{(1/2)} (VII),
R¹⁰₂SiO_{(2/2)} (VIII),
R¹⁰SiO_{(3/2)} (IX), and
SiO_{(4/2)} (X),
where each R¹⁰ is independently residues of —H, —OH, —OR, or a hydrocarbon with from 1 to 40 carbon residues and optionally substituted with one or more halogens, at least about 20 mol % of the units are selected from the group consisting of units of the general formulae IX and X, and a maximum of 10 wt % of the R¹⁰ residues are —OH and —OR residues; and
3) a maximum of 5 parts by weight of water.

31. The method of claim 30, wherein the mixture is an emulsion of the polysiloxane-silicone resin mixture and at least 10 parts by weight of water.

32. The method of claim 30, wherein the fabric care composition is in a form selected from the group consisting of a detergent, a heavy duty liquid detergent, powder detergent, a laundry rinse additive, a pretreatment, a wash additive, a fabric enhancer, a laundry spray, a post-rinse fabric treatment, an ironing aid, a unit dose formulation, a dry cleaning composition, a delayed delivery formulation, and combinations of any thereof.

33. A fabric care composition comprising:
a) a mixture comprising:
i) a hydrophobic fluid comprising silicon containing moieties or fluorine containing moieties, wherein the hydrophobic fluid is dispersible in water; and
ii) a particulate material having a particle size ranging from about 1 nm to about 10,000 nm;
b) an amphoteric or cationic oligomeric/polymeric deposition aid; and
c) a dispersant aid selected from the group consisting of a non-ionic surfactant, a polymeric surfactant, a silicone-based surfactant and combinations thereof.

34. The fabric care composition of claim 33 where in the dispersant aid is selected from the group consisting of tallow alkyl ethoxylate, polyvinyl alcohols, polyvinyl pyrrolidones and mixtures thereof.

35. The fabric care composition of claim 1, wherein the composition further comprises a solvent.

36. The fabric care composition of claim 35, wherein the solvent is an organic solvent,

37. The fabric care composition of claim 36, wherein the organic solvent is mono- or polyalcohols and ethers and mixtures thereof; the organic solvent can be selected from ethanol, n-propanol, isopropanol, butanol, ethylene glycol, propylene glycol, ethylene glycol monobutyl ether, ethylene glycol monoethyl ether and diethylene glycol monoethyl ether.
